(19) United States
(12) Patent Application Publication
(10) Pub. No.: US 2014/0286417 A1
(43) Pub. Date: Sep. 25, 2014

(54) DATA ENCODING AND DECODING

(71) Applicant: Sony Corporation, Minato-ku, Tokyo (JP)

(72) Inventors: James Alexander Gamei, Surrey (GB); Karl James Sharman, Hampshire (GB)

(73) Assignee: Sony Corporation, Minato-ku, Tokyo (JP)

(21) Appl. No.: 14/352,456

(22) PCT Filed: Nov. 6, 2012
(86) PCT No.: PCT/GB2012/052758

§ 371 Date: Apr. 17, 2014

(30) Foreign Application Priority Data
Nov. 7, 2011 (GB) 1119180.6
Nov. 15, 2011 (GB) 1119687.0

(51) Int. Cl. H04N 19/61; H04N 19/91

(52) U.S. Cl. CPC H04N 19/00781; H04N 19/00951
USPC 375/240.12

(57) ABSTRACT

A data coding apparatus in which a set of ordered data is encoded includes: an entropy encoder encoding the ordered data, wherein each data item is split into respective data subsets that are encoded by first and second encoding systems so that for a predetermined quantity of encoded data generated in respect of a group of data items by the first encoding system, a variable quantity of zero or more data is generated in respect of that group of data by the second encoding system; and an output data stream assembler generating an output data stream from the encoded data, the output data stream including successive packets of a predetermined quantity of data generated by the first encoding system followed, in a data stream order, by the zero or more data generated by the second encoding system in respect of same data items as encoded by the first encoding system.

### CROSS REFERENCE TO RELATED APPLICATION

The present application claims the benefit of the earlier filing date of GB1119687.0 and GB1119180.6 both filed in the United Kingdom Intellectual Property Office on 15 Nov. 2011 and 7 Nov. 2011 respectively, the entire content of which applications is incorporated herein by reference.

### FIELD OF THE INVENTION

This invention relates to data encoding and decoding.

### DESCRIPTION OF THE RELATED ART

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

As an example of data encoding and decoding techniques, there are several video data compression and decompression systems which involve transforming video data into a frequency domain representation, quantising the frequency domain coefficients and then applying some form of entropy encoding to the quantised coefficients.

Entropy, in the present context, can be considered as representing the information content of a data symbol or series of symbols. The aim of entropy encoding is to encode a series of data symbols in a lossless manner using (ideally) the smallest number of encoded data bits which are necessary to represent the information content of that series of data symbols. In practice, entropy encoding is used to encode the quantised coefficients such that the encoded data is smaller (in terms of its number of bits) then the data size of the original quantised coefficients. A more efficient entropy encoding process gives a smaller output data size for the same input data size.

One technique for entropy encoding video data is the so-called CABAC (context adaptive binary arithmetic coding) technique. This is an example of a more generalised arithmetic coding (AC) technique. In an example implementation, the quantised coefficients are divided into data indicating positions, relative to an array of the coefficients, of coefficient values of certain magnitudes and their signs. So, for example, a so-called “significance map” may indicate positions in an array of coefficients where the coefficient at that position has a non-zero value. Other maps may indicate where the data has a value of one or more; or where the data has a value of two or more.

In a basic example of a CABAC encoder and decoder, the significance map is encoded as CABAC data but some of the other maps are encoded as so-called bypass data (being data encoded as CABAC but with a fixed 50% probability context model). The significance maps and the other maps are all representative of different respective attributes or value ranges of the same initial data items. Accordingly, each data item is split into respective subsets of data and the respective subsets are encoded by first (for example, CABAC) and second (for example, bypass) encoding systems.

Generally speaking, the bypass data cannot be introduced into the same data stream as the CABAC encoded data in a raw form as, for any given output CABAC-decoded data bit, the CABAC decoder has already read more bits from the data stream than the encoder had written when the encoder was encoding that particular data bit. In other words, the CABAC decoder reads ahead, in terms of reading further CABAC encoded data from the data stream, and so it is not generally considered possible to introduce the bypass data into the same continuous encoded data stream as the CABAC data.

### SUMMARY

This invention provides data coding apparatus in which a set of ordered data is encoded, comprising:

an entropy encoder for encoding the ordered data, in which each data item is split into respective subsets of data and the respective subsets are encoded by first and second encoding systems so that for a predetermined quantity of encoded data generated in respect of a group of data items by the first encoding system, a variable quantity of zero or more data is generated in respect of that group of data by the second encoding system; and

an output data stream assembler for generating an output data stream from the data encoded by the first and second encoding systems, the output data stream comprising successive packets of a predetermined quantity of data generated by the first encoding system followed, in a data stream order, by the zero or more data generated by the second encoding system in respect of the same data items as those encoded by the first encoding system.

Embodiments of the invention allow (for example) bypass data to be available at a predetermined location in the stream, by dividing the CABAC data into packets of a predetermined length and following each packet by the bypass data (if any) corresponding to the coefficients encoded as CABAC data. Using such a technique, bypass data can be interpreted at the same time as CABAC data. Accordingly, embodiments of the invention provide a method of splitting the CABAC stream so that bypass data may be placed in the stream in raw form so as to form a composite CABAC/bypass data stream and potentially may be interpreted (at decoding) in parallel with CABAC data.

In one example, in some systems so-called bypass data are coded into the CABAC stream by encoding each bit as if it were a CABAC bit, but with a fixed probability (context) of 50%. This effectively involves multiplication of the current range by the bypass bits during encode, and requires iterative logic (or a divide) to decode multiple bits. Bypass data cannot be directly introduced into the bit-stream because the decoder has no way of knowing which bits are bypass data and which are CABAC data.

However, by placing the bypass data at specific positions in the stream that are known to both the encoder and decoder, it not only becomes possible to write bypass data in raw binary form, allowing multiple bits to be read simply, but also allows the bypass bits to be decoded in parallel. This would allow the bypass data (e.g. sign) to be decoded in parallel with the CABAC data (e.g. Significance Map).

The techniques described below can aim to achieve this by arranging the data into packets of defined size, supporting parallel decoding.

Note that CABAC is just one example; the invention is applicable to other types of coding including (without limitation) general arithmetic coding techniques.

Embodiments of the invention can also provide a data encoder in which a buffer for accumulating data renormalized from a register indicating a lower limit of a CABAC range, and for associating the stored data as a group if the group has at least a predetermined data quantity;

a detector for detecting whether all of the data in a group have the data value one with no carry, and if so for designating the group as a group of a first type; if not, the group is designated as a group of a second type;

a buffer reader for reading a group of the first type from the buffer if a subsequently stored group is of the second type, and inserting the read group into an output data stream;

a detector for detecting the presence in the buffer of more than a predetermined number of groups of the first type, and if so, for terminating and restarting encoding of the data.

Further respective aspects and features of the present invention are defined in the appended claims.

It is to be understood that both the foregoing general description of the invention and the following detailed description are exemplary, but not restrictive of, the invention.

### BRIEF DESCRIPTION OF THE DRAWINGS

A more complete appreciation of the disclosure and many of the attendant advantages thereof will be readily obtained as the same becomes better understood by reference to the following detailed description of embodiments of the invention, when considered in connection with the accompanying drawings, wherein:

FIG. 1 schematically illustrates an audio/video (NV) data transmission and reception system using video data compression and decompression;

FIG. 2 schematically illustrates a video display system using video data decompression;

FIG. 3 schematically illustrates an audio/video storage system using video data compression and decompression;

FIG. 4 schematically illustrates a video camera using video data compression;

FIG. 5 provides a schematic overview of a video data compression and decompression apparatus;

FIG. 6 schematically illustrates the generation of predicted images;

FIG. 7 schematically illustrates a largest coding unit (LCU);

FIG. 8 schematically illustrates a set of four coding units (CU);

FIGS. 9 and 10 schematically illustrate the coding units of FIG. 8 sub-divided into smaller coding units;

FIG. 11 schematically illustrates an array of prediction units (PU);

FIG. 12 schematically illustrates an array of transform units (TU);

FIG. 13 schematically illustrates a partially-encoded image;

FIG. 14 schematically illustrates a set of possible prediction directions;

FIG. 15 schematically illustrates a set of prediction modes;

FIG. 16 schematically illustrates a zigzag scan;

FIG. 17 schematically illustrates a CABAC entropy encoder;

FIG. 18 schematically illustrates a CAVLC entropy encoding process;

FIGS. 19A to 19D schematically illustrate aspects of a CABAC encoding and decoding operation;

FIG. 20 schematically illustrates a CABAC encoder;

FIG. 21 schematically illustrates a CABAC decoder;

FIG. 22 schematically illustrates a CABAC encoder with a separate bypass encoder;

FIG. 23 schematically illustrates an encoder acting as a CABAC encoder and a bypass encoder;

FIG. 24 schematically illustrates a CABAC decoder with a separate bypass decoder;

FIG. 25 schematically illustrates a decoder acting as a CABAC decoder and a bypass decoder;

FIG. 26 schematically illustrates a common buffer;

FIG. 27 schematically illustrates a packetised data stream;

FIGS. 28 and 29 schematically illustrate the use of data write pointers;

FIGS. 30 and 31 schematically illustrate the use of data read pointers; and

FIG. 32 schematically illustrates stages in the operation of a CABAC and bypass decoding process.

### DESCRIPTION OF THE EMBODIMENTS

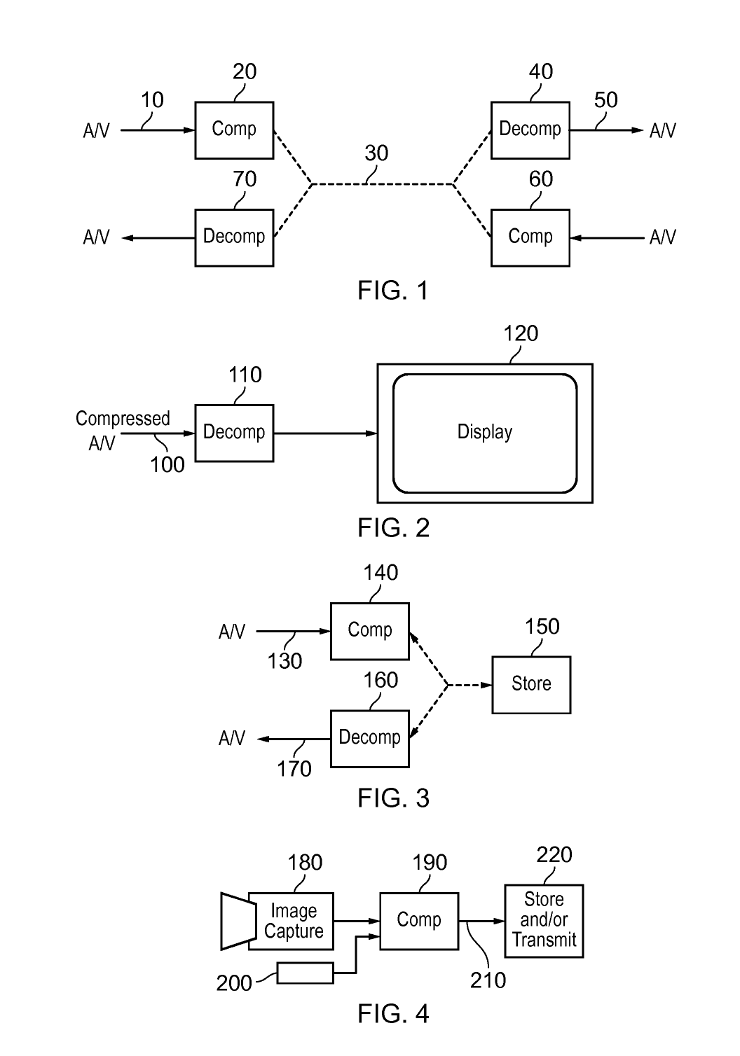

Referring now to the drawings, FIGS. 1-4 are provided to give schematic illustrations of apparatus or systems making use of the compression and/or decompression apparatus to be described below in connection with embodiments of the invention.

All of the data compression and/or decompression apparatus is to be described below may be implemented in hardware, in software running on a general-purpose data processing apparatus such as a general-purpose computer, as programmable hardware such as an application specific integrated circuit (ASIC) or field programmable gate array (FPGA) or as combinations of these. In cases where the embodiments are implemented by software and/or firmware, it will be appreciated that such software and/or firmware, and non-transitory machine-readable data storage media by which such software and/or firmware are stored or otherwise provided, are considered as embodiments of the present invention.

FIG. 1 schematically illustrates an audio/video data transmission and reception system using video data compression and decompression.

An input audio/video signal 10 is supplied to a video data compression apparatus 20 which compresses at least the video component of the audio/video signal 10 for transmission along a transmission route 30 such as a cable, an optical fibre, a wireless link or the like. The compressed signal is processed by a decompression apparatus 40 to provide an output audio/video signal 50. For the return path, a compression apparatus 60 compresses an audio/video signal for transmission along the transmission route 30 to a decompression apparatus 70.

The compression apparatus 20 and decompression apparatus 70 can therefore form one node of a transmission link. The decompression apparatus 40 and decompression apparatus 60 can form another node of the transmission link. Of course, in instances where the transmission link is uni-directional, only one of the nodes would require a compression apparatus and the other node would only require a decompression apparatus.

FIG. 2 schematically illustrates a video display system using video data decompression. In particular, a compressed audio/video signal 100 is processed by a decompression apparatus 110 to provide a decompressed signal which can be displayed on a display 120. The decompression apparatus 110 could be implemented as an integral part of the display 120, for example being provided within the same casing as the display device. Alternatively, the decompression apparatus 110 might be provided as (for example) a so-called set top box (STB), noting that the expression “set-top” does not imply a requirement for the box to be sited in any particular orientation or position with respect to the display 120; it is simply a term used in the art to indicate a device which is connectable to a display as a peripheral device.

FIG. 3 schematically illustrates an audio/video storage system using video data compression and decompression. An input audio/video signal 130 is supplied to a compression apparatus 140 which generates a compressed signal for storing by a store device 150 such as a magnetic disk device, an optical disk device, a magnetic tape device, a solid state storage device such as a semiconductor memory or other storage device. For replay, compressed data is read from the store device 150 and passed to a decompression apparatus 160 for decompression to provide an output audio/video signal 170.

It will be appreciated that the compressed or encoded signal, and a storage medium storing that signal, are considered as embodiments of the present invention.

FIG. 4 schematically illustrates a video camera using video data compression. In FIG. 4, and image capture device 180, such as a charge coupled device (CCD) image sensor and associated control and read-out electronics, generates a video signal which is passed to a compression apparatus 190. A microphone (or plural microphones) 200 generates an audio signal to be passed to the compression apparatus 190. The compression apparatus 190 generates a compressed audio/video signal 210 to be stored and/or transmitted (shown generically as a schematic stage 220).

The techniques to be described below relate primarily to video data compression. It will be appreciated that many existing techniques may be used for audio data compression in conjunction with the video data compression techniques which will be described, to generate a compressed audio/video signal. Accordingly, a separate discussion of audio data compression will not be provided. It will also be appreciated that the data rate associated with video data, in particular broadcast quality video data, is generally very much higher than the data rate associated with audio data (whether compressed or uncompressed). It will therefore be appreciated that uncompressed audio data could accompany compressed video data to form a compressed audio/video signal. It will further be appreciated that although the present examples (shown in FIGS. 1-4) relate to audio/video data, the techniques to be described below can find use in a system which simply deals with (that is to say, compresses, decompresses, stores, displays and/or transmits) video data. That is to say, the embodiments can apply to video data compression without necessarily having any associated audio data handling at all.

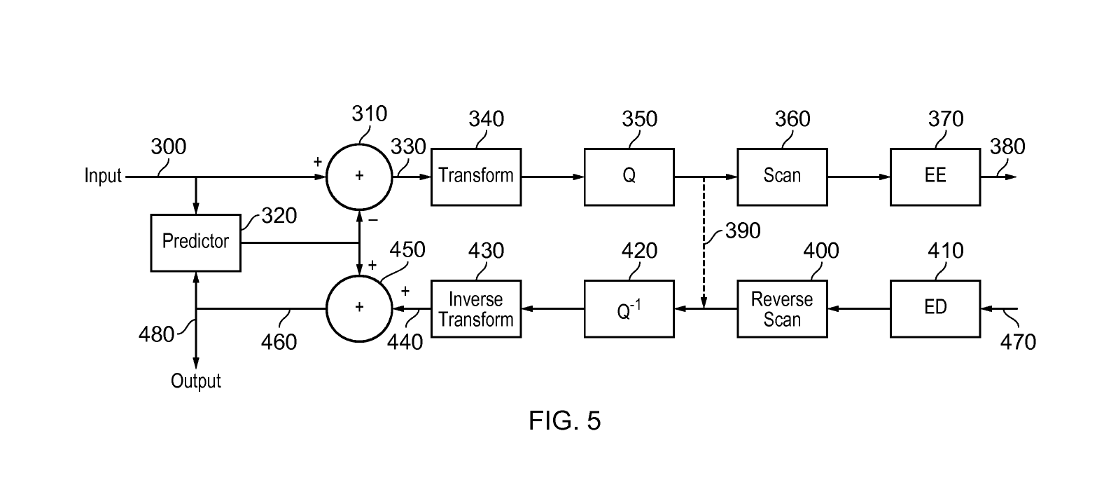

FIG. 5 provides a schematic overview of a video data compression and decompression apparatus.

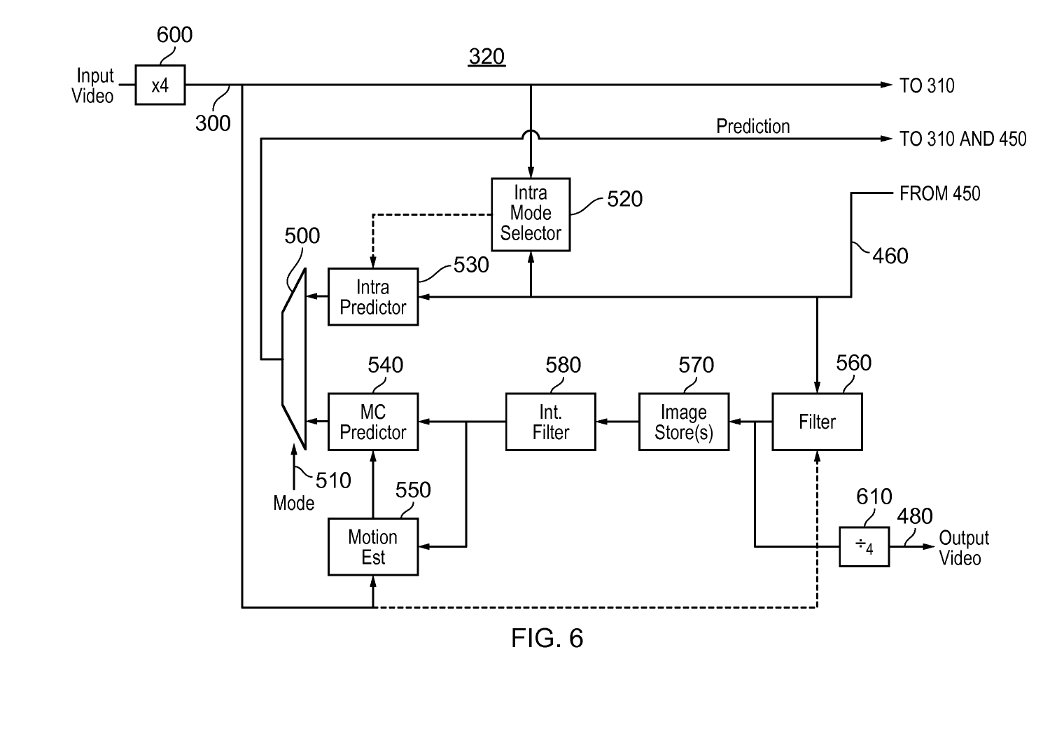

Successive images of an input video signal 300 are supplied to an adder 310 and to an image predictor 320. The image predictor 320 will be described below in more detail with reference to FIG. 6. The adder 310 in fact performs a subtraction (negative addition) operation, in that it receives the input video signal 300 on a “+” input and the output of the image predictor 320 on a “−” input, so that the predicted image is subtracted from the input image. The result is to generate a so-called residual image signal 330 representing the difference between the actual and projected images.

One reason why a residual image signal is generated is as follows. The data coding techniques to be described, that is to say the techniques which will be applied to the residual image signal, tends to work more efficiently when there is less “energy” in the image to be encoded. Here, the term “efficiently” refers to the generation of a small amount of encoded data; for a particular image quality level, it is desirable (and considered “efficient”) to generate as little data as is practicably possible. The reference to “energy” in the residual image relates to the amount of information contained in the residual image. If the predicted image were to be identical to the real image, the difference between the two (that is to say, the residual image) would contain zero information (zero energy) and would be very easy to encode into a small amount of encoded data. In general, if the prediction process can be made to work reasonably well, the expectation is that the residual image data will contain less information (less energy) than the input image and so will be easier to encode into a small amount of encoded data.

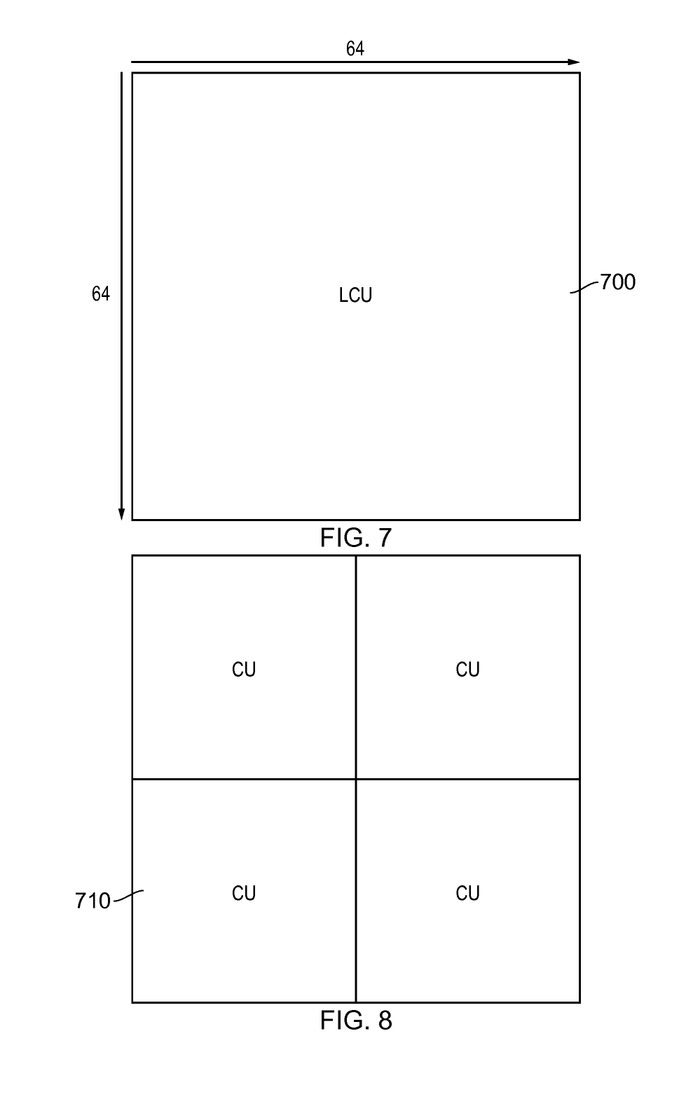

The residual image data 330 is supplied to a transform unit 340 which generates a discrete cosine transform (DCT) representation of the residual image data. The DCT technique itself is well known and will not be described in detail here. There are however aspects of the techniques used in the present apparatus which will be described in more detail below, in particular relating to the selection of different blocks of data to which the DCT operation is applied. These will be discussed with reference to FIGS. 7-12 below.

The output of the transform unit 340, which is to say, a set of DCT coefficients for each transformed block of image data, is supplied to a quantiser 350. Various quantisation techniques are known in the field of video data compression, ranging from a simple multiplication by a quantisation scaling factor through to the application of complicated lookup tables under the control of a quantisation parameter. The general aim is twofold. Firstly, the quantisation process reduces the number of possible values of the transformed data. Secondly, the quantisation process can increase the likelihood that values of the transformed data are zero. Both of these can make the entropy encoding process, to be described below, work more efficiently in generating small amounts of compressed video data.

A data scanning process is applied by a scan unit 360. The purpose of the scanning process is to reorder the quantised transformed data so as to gather as many as possible of the non-zero quantised transformed coefficients together, and of course therefore to gather as many as possible of the zero-valued coefficients together. These features can allow so-called run-length coding or similar techniques to be applied efficiently. So, the scanning process involves selecting coefficients from the quantised transformed data, and in particular from a block of coefficients corresponding to a block of image data which has been transformed and quantised, according to a “scanning order” so that (a) all of the coefficients are selected once as part of the scan, and (b) the scan tends to provide the desired reordering. Techniques for selecting a scanning order will be described below. One example scanning order which can tend to give useful results is a so-called zigzag scanning order.

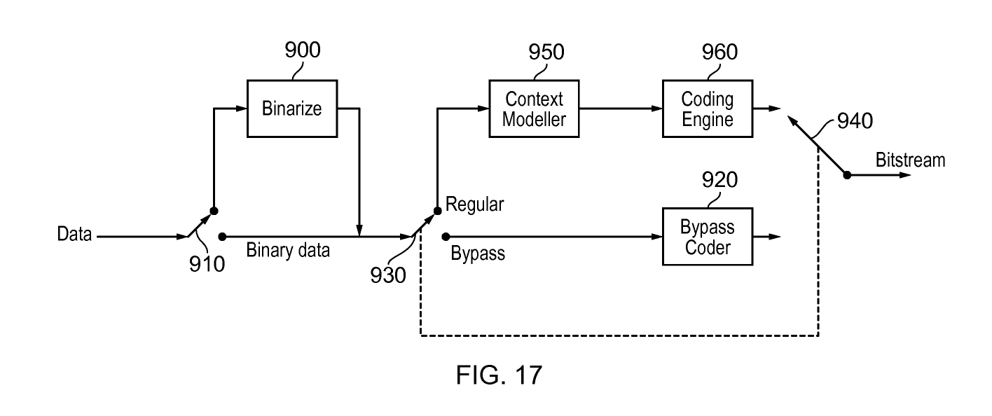

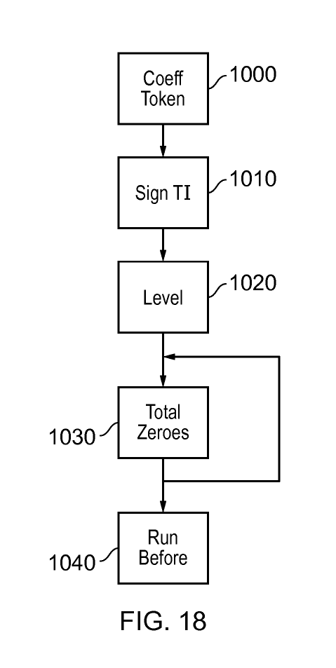

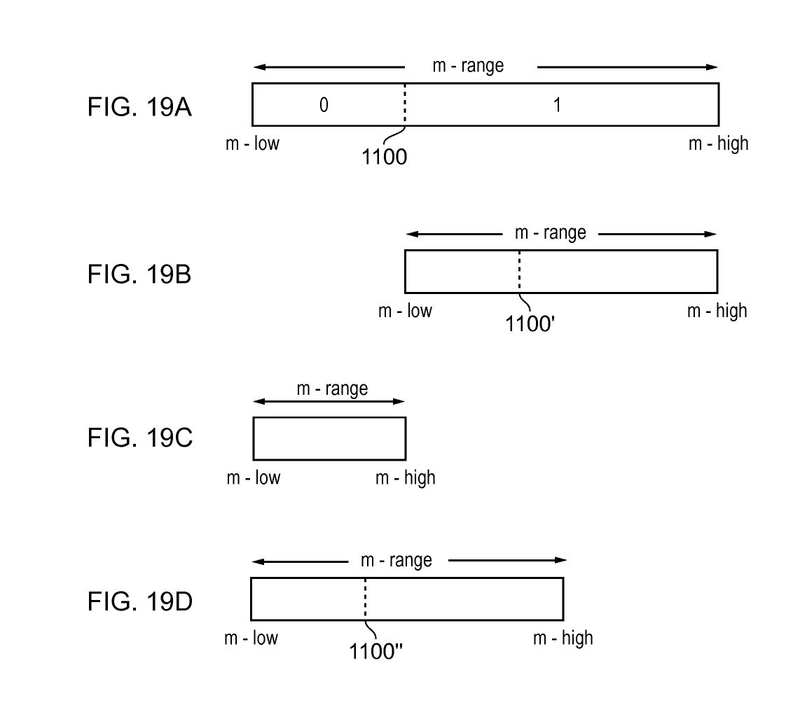

The scanned coefficients are then passed to an entropy encoder (EE) 370. Again, various types of entropy encoding may be used. Two examples which will be described below are variants of the so-called CABAC (Context Adaptive Binary Arithmetic Coding) system and variants of the so-called CAVLC (Context Adaptive Variable-Length Coding) system. In general terms, CABAC is considered to provide a better efficiency, and in some studies has been shown to provide a 10-20% reduction in the quantity of encoded output data for a comparable image quality compared to CAVLC. However, CAVLC is considered to represent a much lower level of complexity (in terms of its implementation) than CABAC. The CABAC technique will be discussed with reference to FIG. 17 below, and the CAVLC technique will be discussed with reference to FIGS. 18 and 19 below.

Note that the scanning process and the entropy encoding process are shown as separate processes, but in fact can be combined or treated together. That is to say, the reading of data into the entropy encoder can take place in the scan order. Corresponding considerations apply to the respective inverse processes to be described below.

The output of the entropy encoder 370, along with additional data (mentioned above and/or discussed below), for example defining the manner in which the predictor 320 generated the predicted image, provides a compressed output video signal 380.

However, a return path is also provided because the operation of the predictor 320 itself depends upon a decompressed version of the compressed output data.

The reason for this feature is as follows. At the appropriate stage in the decompression process (to be described below) a decompressed version of the residual data is generated. This decompressed residual data has to be added to a predicted image to generate an output image (because the original residual data was the difference between the input image and a predicted image). In order that this process is comparable, as between the compression side and the decompression side, the predicted images generated by the predictor 320 should be the same during the compression process and during the decompression process. Of course, at decompression, the apparatus does not have access to the original input images, but only to the decompressed images. Therefore, at compression, the predictor 320 bases its prediction (at least, for inter-image encoding) on decompressed versions of the compressed images.

The entropy encoding process carried out by the entropy encoder 370 is considered to be “lossless”, which is to say that it can be reversed to arrive at exactly the same data which was first supplied to the entropy encoder 370. So, the return path can be implemented before the entropy encoding stage. Indeed, the scanning process carried out by the scan unit 360 is also considered lossless, but in the present embodiment the return path 390 is from the output of the quantiser 350 to the input of a complimentary inverse quantiser 420.

In general terms, an entropy decoder 410, the reverse scan unit 400, an inverse quantiser 420 and an inverse transform unit 430 provide the respective inverse functions of the entropy encoder 370, the scan unit 360, the quantiser 350 and the transform unit 340. For now, the discussion will continue through the compression process; the process to decompress an input compressed video signal will be discussed separately below.

In the compression process, the scanned coefficients are passed by the return path 390 from the quantiser 350 to the inverse quantiser 420 which carries out the inverse operation of the scan unit 360. An inverse quantisation and inverse transformation process are carried out by the units 420, 430 to generate a compressed-decompressed residual image signal 440.

The image signal 440 is added, at an adder 450, to the output of the predictor 320 to generate a reconstructed output image 460. This forms one input to the image predictor 320, as will be described below.

Turning now to the process applied to a received compressed video signal 470, the signal is supplied to the entropy decoder 410 and from there to the chain of the reverse scan unit 400, the inverse quantiser 420 and the inverse transform unit 430 before being added to the output of the image predictor 320 by the adder 450. In straightforward terms, the output 460 of the adder 450 forms the output decompressed video signal 480. In practice, further filtering may be applied before the signal is output.

FIG. 6 schematically illustrates the generation of predicted images, and in particular the operation of the image predictor 320.

There are two basic modes of prediction: so-called intra-image prediction and so-called inter-image, or motion-compensated (MC), prediction.

Intra-image prediction bases a prediction of the content of a block of the image on data from within the same image. This corresponds to so-called I-frame encoding in other video compression techniques. In contrast to I-frame encoding, where the whole image is intra-encoded, in the present embodiments the choice between intra- and inter-encoding can be made on a block-by-block basis, though in other embodiments of the invention the choice is still made on an image-by-image basis.

Motion-compensated prediction makes use of motion information which attempts to define the source, in another adjacent or nearby image, of image detail to be encoded in the current image. Accordingly, in an ideal example, the contents of a block of image data in the predicted image can be encoded very simply as a reference (a motion vector) pointing to a corresponding block at the same or a slightly different position in an adjacent image.

Returning to FIG. 6, two image prediction arrangements (corresponding to intra- and inter-image prediction) are shown, the results of which are selected by a multiplexer 500 under the control of a mode signal 510 so as to provide blocks of the predicted image for supply to the adders 310 and 450. The choice is made in dependence upon which selection gives the lowest “energy” (which, as discussed above, may be considered as information content requiring encoding), and the choice is signalled to the encoder within the encoded output datastream. Image energy, in this context, can be detected, for example, by carrying out a trial subtraction of an area of the two versions of the predicted image from the input image, squaring each pixel value of the difference image, summing the squared values, and identifying which of the two versions gives rise to the lower mean squared value of the difference image relating to that image area.

The actual prediction, in the intra-encoding system, is made on the basis of image blocks received as part of the signal 460, which is to say, the prediction is based upon encoded-decoded image blocks in order that exactly the same prediction can be made at a decompression apparatus. However, data can be derived from the input video signal 300 by an intra-mode selector 520 to control the operation of the intra-image predictor 530.

For inter-image prediction, a motion compensated (MC) predictor 540 uses motion information such as motion vectors derived by a motion estimator 550 from the input video signal 300. Those motion vectors are applied to a processed version of the reconstructed image 460 by the motion compensated predictor 540 to generate blocks of the inter-image prediction.

The processing applied to the signal 460 will now be described. Firstly, the signal is filtered by a filter unit 560. This involves applying a “deblocking” filter to remove or at least tend to reduce the effects of the block-based processing carried out by the transform unit 340 and subsequent operations. Also, an adaptive loop filter is applied using coefficients derived by processing the reconstructed signal 460 and the input video signal 300. The adaptive loop filter is a type of filter which, using known techniques, applies adaptive filter coefficients to the data to be filtered. That is to say, the filter coefficients can vary in dependence upon various factors. Data defining which filter coefficients to use is included as part of the encoded output datastream.

The filtered output from the filter unit 560 in fact forms the output video signal 480. It is also buffered in one or more image stores 570; the storage of successive images is a requirement of motion compensated prediction processing, and in particular the generation of motion vectors. To save on storage requirements, the stored images in the image stores 570 may be held in a compressed form and then decompressed for use in generating motion vectors. For this particular purpose, any known compression/decompression system may be used. The stored images are passed to an interpolation filter 580 which generates a higher resolution version of the stored images; in this example, intermediate samples (sub-samples) are generated such that the resolution of the interpolated image is output by the interpolation filter 580 is 8 times (in each dimension) that of the images stored in the image stores 570. The interpolated images are passed as an input to the motion estimator 550 and also to the motion compensated predictor 540.

In embodiments of the invention, a further optional stage is provided, which is to multiply the data values of the input video signal by a factor of four using a multiplier 600 (effectively just shifting the data values left by two bits), and to apply a corresponding divide operation (shift right by two bits) at the output of the apparatus using a divider or right-shifter 610. So, the shifting left and shifting right changes the data purely for the internal operation of the apparatus. This measure can provide for higher calculation accuracy within the apparatus, as the effect of any data rounding errors is reduced.

The way in which an image is partitioned for compression processing will now be described. At a basic level, and image to be compressed is considered as an array of blocks of samples. For the purposes of the present discussion, the largest such block under consideration is a so-called largest coding unit (LCU) 700 (FIG. 7), which represents a square array of 64×64 samples. Here, the discussion relates to luminance samples. Depending on the chrominance mode, such as 4:4:4, 4:2:2, 4:2:0 or 4:4:4:4 (GBR plus key data), there will be differing numbers of corresponding chrominance samples corresponding to the luminance block.

Three basic types of blocks will be described: coding units, prediction units and transform units. In general terms, the recursive subdividing of the LCUs allows an input picture to be partitioned in such a way that both the block sizes and the block coding parameters (such as prediction or residual coding modes) can be set according to the specific characteristics of the image to be encoded.

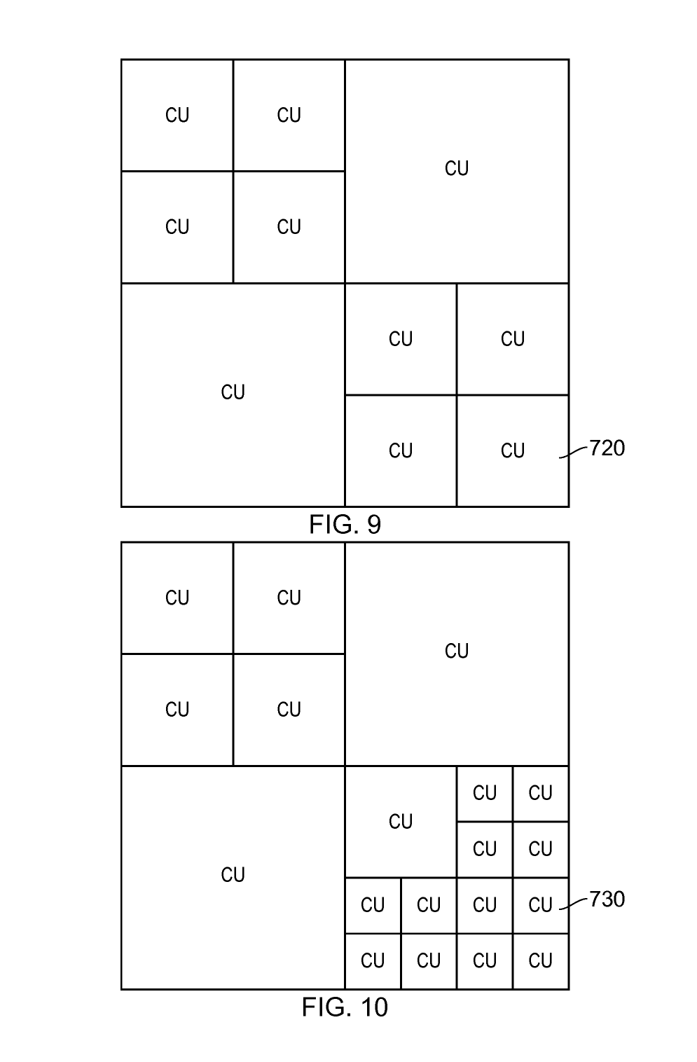

The LCU may be subdivided into so-called coding units (CU). Coding units are always square and have a size between 8×8 samples and the full size of the LCU 700. The coding units can be arranged as a kind of tree structure, so that a first subdivision may take place as shown in FIG. 8, giving coding units 710 of 32×32 samples; subsequent subdivisions may then take place on a selective basis so as to give some coding units 720 of 16×16 samples (FIG. 9) and potentially some coding units 730 of 8×8 samples (FIG. 10). Overall, this process can provide a content-adapting coding tree structure of CU blocks, each of which may be as large as the LCU or as small as 8×8 samples. Encoding of the output video data takes place on the basis of the coding unit structure.

FIG. 11 schematically illustrates an array of prediction units (PU). A prediction unit is a basic unit for carrying information relating to the image prediction processes, or in other words the additional data added to the entropy encoded residual image data to form the output video signal from the apparatus of FIG. 5. In general, prediction units are not restricted to being square in shape. They can take other shapes, in particular rectangular shapes forming half of one of the square coding units, as long as the coding unit is greater than the minimum (8×8) size. The aim is to allow the boundary of adjacent prediction units to match (as closely as possible) the boundary of real objects in the picture, so that different prediction parameters can be applied to different real objects. Each coding unit may contain one or more prediction units.

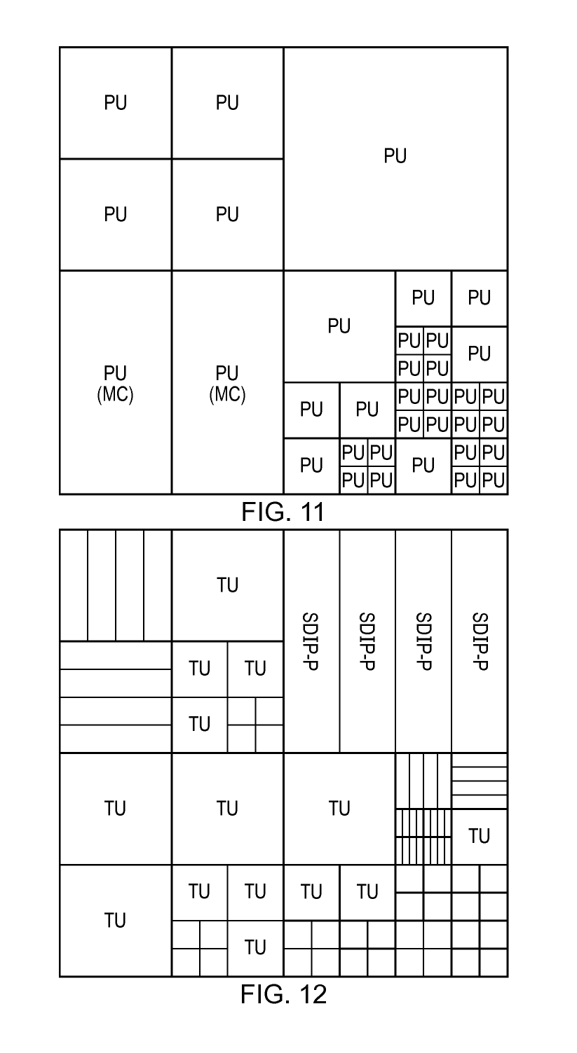

FIG. 12 schematically illustrates an array of transform units (TU). A transform unit is a basic unit of the transform and quantisation process. Transform units are always square and can take a size from 4×4 up to 32×32 samples. Each coding unit can contain one or more transform units. The acronym SDIP-P in FIG. 12 signifies a so-called short distance intra-prediction partition. In this arrangement only one dimensional transforms are used, so a 4×N block is passed through N transforms with input data to the transforms being based upon the previously decoded neighbouring blocks and the previously decoded neighbouring lines within the current SDIP-P.

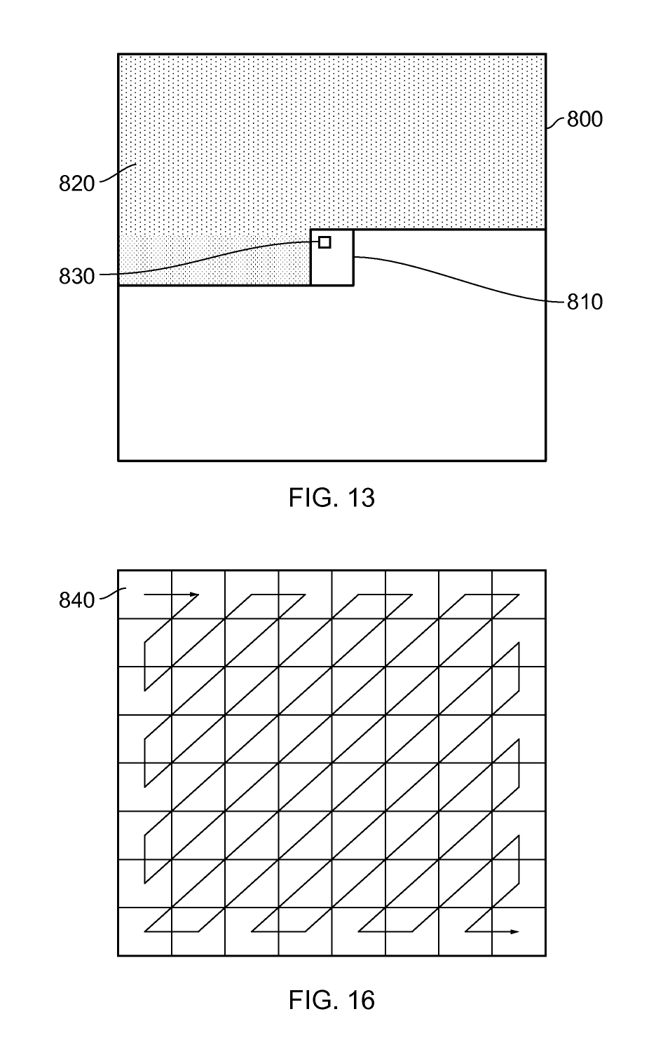

The intra-prediction process will now be discussed. In general terms, intra-prediction involves generating a prediction of a current block (a prediction unit) of samples from previously-encoded and decoded samples in the same image. FIG. 13 schematically illustrates a partially encoded image 800. Here, the image is being encoded from top-left to bottom-right on an LCU basis. An example LCU encoded partway through the handling of the whole image is shown as a block 810. A shaded region 820 above and to the left of the block 810 has already been encoded. The intra-image prediction of the contents of the block 810 can make use of any of the shaded area 820 but cannot make use of the unshaded area below that.

The block 810 represents an LCU; as discussed above, for the purposes of intra-image prediction processing, this may be subdivided into a set of smaller prediction units. An example of a prediction unit 830 is shown within the LCU 810.

The intra-image prediction takes into account samples above and/or to the left of the current LCU 810. Source samples, from which the required samples are predicted, may be located at different positions or directions relative to a current prediction unit within the LCU 810. To decide which direction is appropriate for a current prediction unit, the results of a trial prediction based upon each candidate direction are compared in order to see which candidate direction gives an outcome which is closest to the corresponding block of the input image. The candidate direction giving the closest outcome is selected as the prediction direction for that prediction unit.

The picture may also be encoded on a “slice” basis. In one example, a slice is a horizontally adjacent group of LCUs. But in more general terms, the entire residual image could form a slice, or a slice could be a single LCU, or a slice could be a row of LCUs, and so on. Slices can give some resilience to errors as they are encoded as independent units. The encoder and decoder states are completely reset at a slice boundary. For example, intra-prediction is not carried out across slice boundaries; slice boundaries are treated as image boundaries for this purpose.

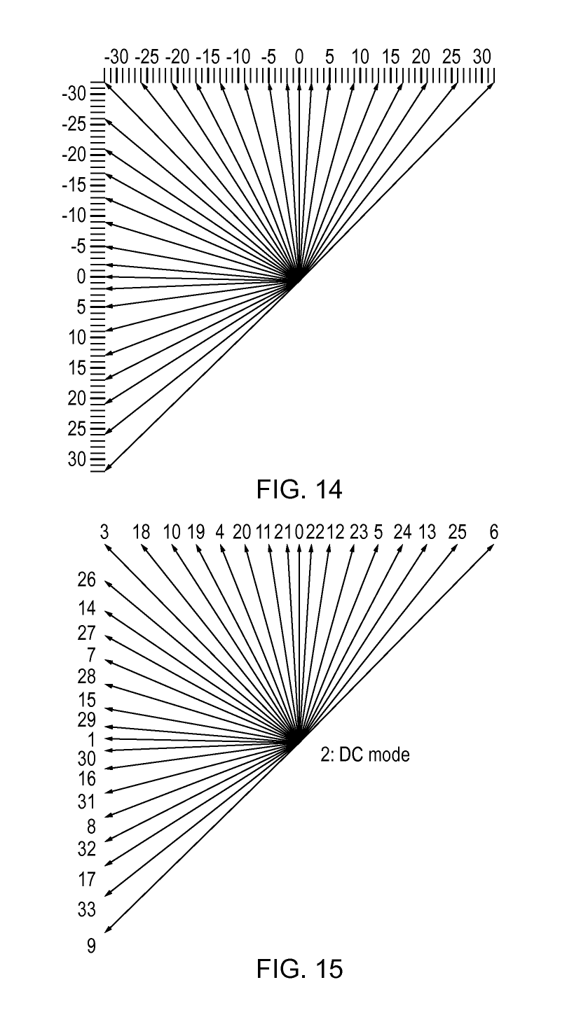

FIG. 14 schematically illustrates a set of possible (candidate) prediction directions. The full set of 34 candidate directions is available to a prediction unit of 8×8, 16×16 or 32×32 samples. The special cases of prediction unit sizes of 4×4 and 64×64 samples have a reduced set of candidate directions available to them (17 candidate directions and 5 candidate directions respectively). The directions are determined by horizontal and vertical displacement relative to a current block position, but are encoded as prediction “modes”, a set of which is shown in FIG. 15. Note that the so-called DC mode represents a simple arithmetic mean of the surrounding upper and left-hand samples.

FIG. 16 schematically illustrates a zigzag scan, being a scan pattern which may be applied by the scan unit 360. In FIG. 16, the pattern is shown for an example block of 8×8 DCT coefficients, with the DC coefficient being positioned at the top left position 840 of the block, and increasing horizontal and vertical spatial frequencies being represented by coefficients at increasing distances downwards and to the right of the top-left position 840.

Note that in some embodiments, the coefficients may be scanned in a reverse order (bottom right to top left using the ordering notation of FIG. 16). Also it should be noted that in some embodiments, the scan may pass from left to right across a few (for example between one and three) uppermost horizontal rows, before carrying out a zig-zag of the remaining coefficients.

FIG. 17 schematically illustrates the operation of a CABAC entropy encoder.

The CABAC encoder operates in respect of binary data, that is to say, data represented by only the two symbols 0 and 1. The encoder makes use of a so-called context modelling process which selects a “context” or probability model for subsequent data on the basis of previously encoded data. The selection of the context is carried out in a deterministic way so that the same determination, on the basis of previously decoded data, can be performed at the decoder without the need for further data (specifying the context) to be added to the encoded datastream passed to the decoder.

Referring to FIG. 17, input data to be encoded may be passed to a binary converter 900 if it is not already in a binary form; if the data is already in binary form, the converter 900 is bypassed (by a schematic switch 910). In the present embodiments, conversion to a binary form is actually carried out by expressing the quantised DCT coefficient data as a series of binary “maps”, which will be described further below.

The binary data may then be handled by one of two processing paths, a “regular” and a “bypass” path (which are shown schematically as separate paths but which, in embodiments of the invention discussed below, could in fact be implemented by the same processing stages, just using slightly different parameters). The bypass path employs a so-called bypass coder 920 which does not necessarily make use of context modelling in the same form as the regular path. In some examples of CABAC coding, this bypass path can be selected if there is a need for particularly rapid processing of a batch of data, but in the present embodiments two features of so-called “bypass” data are noted: firstly, the bypass data is handled by the CABAC encoder (950, 960), just using a fixed context model representing a 50% probability; and secondly, the bypass data relates to certain categories of data, one particular example being coefficient sign data. Otherwise, the regular path is selected by schematic switches 930, 940. This involves the data being processed by a context modeller 950 followed by a coding engine 960.

The entropy encoder shown in FIG. 17 encodes a block of data (that is, for example, data corresponding to a block of coefficients relating to a block of the residual image) as a single value if the block is formed entirely of zero-valued data. For each block that does not fall into this category, that is to say a block that contains at least some non-zero data, a “significance map” is prepared. The significance map indicates whether, for each position in a block of data to be encoded, the corresponding coefficient in the block is non-zero. The significance map data, being in binary form, is itself CABAC encoded. The use of the significance map assists with compression because no data needs to be encoded for a coefficient with a magnitude that the significance map indicates to be zero. Also, the significance map can include a special code to indicate the final non-zero coefficient in the block, so that all of the final high frequency/trailing zero coefficients can be omitted from the encoding. The significance map is followed, in the encoded bitstream, by data defining the values of the non-zero coefficients specified by the significance map.

Further levels of map data are also prepared and are encoded. An example is a map which defines, as a binary value (1=yes, 0=no) whether the coefficient data at a map position which the significance map has indicated to be “non-zero” actually has the value of “one”. Another map specifies whether the coefficient data at a map position which the significance map has indicated to be “non-zero” actually has the value of “two”. A further map indicates, for those map positions where the significance map has indicated that the coefficient data is “non-zero”, whether the data has a value of “greater than two”. Another map indicates, again for data identified as “non-zero”, the sign of the data value (using a predetermined binary notation such as 1 for +, 0 for −, or of course the other way around).

In embodiments of the invention, the significance maps and the other maps are allocated in a predetermined manner either to the CABAC encoder or to the bypass encoder, and are all representative of different respective attributes or value ranges of the same initial data items. In one example, at least the significance map is CABAC encoded and at least some of the remaining maps (such as the sign data) are bypass encoded. Accordingly, each data item is split into respective subsets of data and the respective subsets are encoded by first (for example, CABAC) and second (for example, bypass) encoding systems. The nature of the data and of the CABAC and bypass encoding is such that for a predetermined quantity of CABAC encoded data, a variable quantity of zero or more bypass data is generated in respect of the same initial data items. So, for example, if the quantised, reordered DCT data contains substantially all zero values, then it may be that no bypass data or a very small quantity of bypass data is generated, because the bypass data concerns only those map positions for which the significance map has indicated that the value is non-zero. In another example, in quantised reordered DCT data having many high value coefficients, a significant quantity of bypass data might be generated.

In embodiments of the invention, the significance map and other maps are generated from the quantised DCT coefficients, for example by the scan unit 360, and is subjected to a zigzag scanning process (or a scanning process selected from zigzag, horizontal raster and vertical raster scanning according to the intra-prediction mode) before being subjected to CABAC encoding.

In general terms, CABAC encoding involves predicting a context, or a probability model, for a next bit to be encoded, based upon other previously encoded data. If the next bit is the same as the bit identified as “most likely” by the probability model, then the encoding of the information that “the next bit agrees with the probability model” can be encoded with great efficiency. It is less efficient to encode that “the next bit does not agree with the probability model”, so the derivation of the context data is important to good operation of the encoder. The term “adaptive” means that the context or probability models are adapted, or varied during encoding, in an attempt to provide a good match to the (as yet uncoded) next data.

Using a simple analogy, in the written English language, the letter “U” is relatively uncommon. But in a letter position immediately after the letter “Q”, it is very common indeed. So, a probability model might set the probability of a “U” as a very low value, but if the current letter is a “Q”, the probability model for a “U” as the next letter could be set to a very high probability value.

CABAC encoding is used, in the present arrangements, for at least the significance map and the maps indicating whether the non-zero values are one or two. Bypass processing—which in these embodiments is identical to CABAC encoding but for the fact that the probability model is fixed at an equal (0.5:0.5) probability distribution of 1s and 0s, is used for at least the sign data and the map indicating whether a value is >2. For those data positions identified as >2, a separate so-called escape data encoding can be used to encode the actual value of the data. This may include a Golomb-Rice encoding technique.

The CABAC context modelling and encoding process is described in more detail in WD4: Working Draft 4 of High-Efficiency Video Coding, JCTVC-F803_d5, Draft ISO/IEC 23008-HEVC; 201x(E) 2011 Oct. 28.

FIG. 18 schematically illustrates a CAVLC entropy encoding process.

As with CABAC discussed above, the entropy encoding process shown in FIG. 18 follows the operation of the scan unit 360. It has been noted that the non-zero coefficients in the transformed and scanned residual data are often sequences of ±1. The CAVLC coder indicates the number of high-frequency ±1 coefficients by a variable referred to as “trailing 1s” (T1s). For these non-zero coefficients, the coding efficiency is improved by using different (context-adaptive) variable length coding tables.

Referring to FIG. 18, a first step 1000 generates values “coeff_token” to encode both the total number of non-zero coefficients and the number of trailing ones. At a step 1010, the sign bit of each trailing one is encoded in a reverse scanning order. Each remaining non-zero coefficient is encoded as a “level” variable at a step 1020, thus defining the sign and magnitude of those coefficients. At a step 1030 a variable total_zeros is used to code the total number of zeros preceding the last nonzero coefficient. Finally, at a step 1040, a variable run_before is used to code the number of successive zeros preceding each non-zero coefficient in a reverse scanning order. The collected output of the variables defined above forms the encoded data.

As mentioned above, a default scanning order for the scanning operation carried out by the scan unit 360 is a zigzag scan is illustrated schematically in FIG. 16. In other arrangements, four blocks where intra-image encoding is used, a choice may be made between zigzag scanning, a horizontal raster scan and a vertical raster scan depending on the image prediction direction (FIG. 15) and the transform unit (TU) size.

The CABAC process, discussed above, will now be described in a little more detail.

CABAC, at least as far as it is used in the proposed HEVC system, involves deriving a “context” or probability model in respect of a next bit to be encoded. The context, defined by a context variable or CV, then influences how the bit is encoded. In general terms, if the next bit is the same as the value which the CV defines as the expected more probable value, then there are advantages in terms of reducing the number of output bits needed to define that data bit.

The encoding process involves mapping a bit to be encoded onto a position within a range of code values. The range of code values is shown schematically in FIG. 19A as a series of adjacent integer numbers extending from a lower limit, m_low, to an upper limit, m_high. The difference between these two limits is m_range, where m_range=m_high−m_low. By various techniques to be described below, in a basic CABAC system m_range is constrained to lie between 256 and 512. m_low can be any value. It can start at (say) zero, but can vary as part of the encoding process to be described.

The range of code values, m_range, is divided into two sub-ranges, by a boundary 1100 defined with respect to the context variable as:

boundary=m_low+(CV*m_range)

So, the context variable divides the total range into two sub-ranges or sub-portions, one sub-range being associated with a value (of a next data bit) of zero, and the other being associated with a value (of the next data bit) of one. The division of the range represents the probabilities assumed by the generation of the CV of the two bit values for the next bit to be encoded. So, if the sub-range associated with the value zero is less than half of the total range, this signifies that a zero is considered less probable, as the next symbol, than a one.

Various different possibilities exist for defining which way round the sub-ranges apply to the possible data bit values. In one example, a lower region of the range (that is, from m_low to the boundary) is by convention defined as being associated with the data bit value of zero.

The encoder and decoder maintain a record of which data bit value is the less probable (often termed the “least probable symbol” or LPS). The CV refers to the LPS, so the CV always represents a value of between 0 and 0.5.

A next bit (a current input bit) is now mapped or assigned to a code value within an appropriate sub-range within the range m_range, as divided by the boundary. This is carried out deterministically at both the encoder and the decoder using a technique to be described in more detail below. If the next bit is a 0, a particular code value, representing a position within the sub-range from m_low to the boundary, is assigned to that bit. If the next bit is a 1, a particular code value in the sub-range from the boundary 1100 to m_high is assigned to that bit.

The lower limit m_low and the range m_range are then redefined so as to modify the set of code values in dependence upon the assigned code and the size of the selected sub-range. If the just-encoded bit is a zero, then m_low is unchanged but m_range is redefined to equal m_range*CV. If the just-encoded bit is a one then m_low is moved to the boundary position (m_low+(CV*m_range)) and m_range is redefined as the difference between the boundary and m_high (that is, (1−CV)*m_range).

These alternatives are illustrated schematically in FIGS. 19B and 19C.

In FIG. 19B, the data bit was a one and so m_low was moved up to the previous boundary position. This provides a revised set of code values for use in a next bit encoding sequence. Note that in some embodiments, the value of CV is changed for the next bit encoding, at least in part on the value of the just-encoded bit. This is why the technique refers to “adaptive” contexts. The revised value of CV is used to generate a new boundary 1100′.

In FIG. 19C, a value of zero was encoded, and so m_low remained unchanged but m_high was moved to the previous boundary position. The value m_range is redefined as the new values of m_high−m_low. In this example, this has resulted in m_range falling below its minimum allowable value (such as 256). When this outcome is detected, the value m_range is doubled, that is, shifted left by one bit, as many times as are necessary to restore m_range to the required range of 256 to 512. In other words, the set of code values is successively increased in size until it has at least a predetermined minimum size. An example of this is illustrated in FIG. 19D, which represents the range of FIG. 19C, doubled so as to comply with the required constraints. A new boundary 1100″ is derived from the next value of CV and the revised m_range.

Whenever the range has to be multiplied by two in this way, a process often called “renormalizing”, an output bit is generated (as an output encoded data bit), one such bit for each renormalizing stage.

In this way, the interval m_range is successively modified and renormalized in dependence upon the adaptation of the CV values (which can be reproduced at the decoder) and the encoded bit stream. After a series of bits has been encoded, the resulting interval and the number of renormalizing stage uniquely defines the encoded bitstream. A decoder which knows such a final interval would in principle be able to reconstruct the encoded data. However, the underlying mathematics demonstrate that it is not actually necessary to define the interval to the decoder, but just to define one position within that interval. This is the purpose of the assigned code value, which is maintained at the encoder and passed to the decoder (as a final part of the data stream) at the termination of encoding the data.

The context variable CV is defined as having 64 possible states which successively indicate different probabilities from a lower limit (such as 1%) at CV=63 through to a 50% probability at CV=0.

CV is changed from one bit to the next according to various known factors, which may be different depending on the block size of data to be encoded. In some instances, the state of neighbouring and previous image blocks may be taken into account.

The assigned code value is generated from a table which defines, for each possible value of CV and each possible value of bits 6 and 7 of m_range (noting that bit 9 of m_range is always 1 because of the constraint on the size of m_range), a position or group of positions at which a newly encoded bit should be allocated a code value in the relevant sub-range.

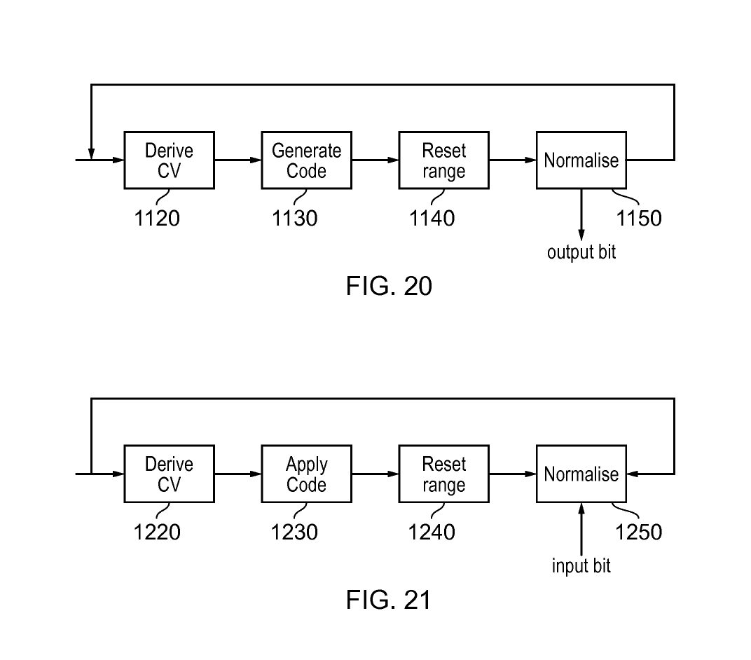

FIG. 20 schematically illustrates a CABAC encoder using the techniques described above.

The CV is initiated (in the case of the first CV) or modified (in the case of subsequent CVs) by a CV derivation unit 1120. A code generator 1130 divides the current m_range according to CV and generates an assigned data code within the appropriate sub_range, using the table mentioned above. A range reset unit 1140 resets m_range to that of the selected sub-range. If necessary, a normaliser 1150 renormalises the m_range, outputting an output bit for each such renormalisation operation. As mentioned, at the end of the process, the assigned code value is also output.

In a decoder, shown schematically in FIG. 21, the CV is initiated (in the case of the first CV) or modified (in the case of subsequent CVs) by a CV derivation unit 1220 which operates in the same way as the unit 1120 in the encoder. A code application unit 1230 divides the current m_range according to CV and detects in which sub-range the data code lies. A range reset unit 1240 resets m_range to that of the selected sub-range. If necessary, a normaliser 1250 renormalises the m_range in response to a received data bit.

In summary, the present techniques allow that CABAC data (that is, data that use context variables) be written to the bit-stream in fixed-sized packets of (in this example) 16 bits, referred to as ‘CABAC packets’. After each ‘CABAC packet’, the corresponding ‘Bypass packet’ is written to the bit-stream.

The ‘Bypass packet’ (which is variable in size) comprises any bypass bits that attach to CABAC data that can be decoded using only the bits contained within preceding ‘CABAC packets’; this bypass data is inserted directly into the stream.

To generate a CABAC Packet-based stream, the encoder can be arranged to track how many bits the decoder has read after each renormalisation process. The encoder can start counting at a number of bits equal to the decoder's initial read (nine in the present embodiments).

Some further background information will now be provided.

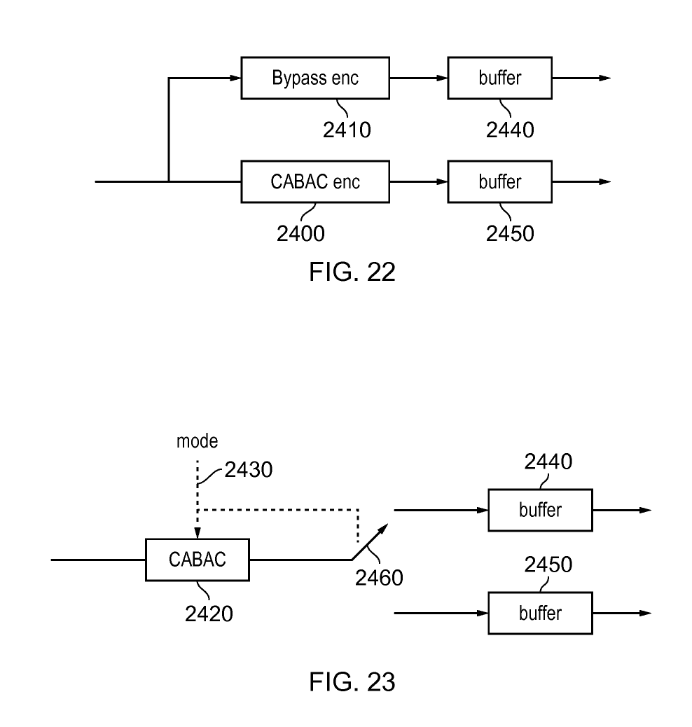

Referring now to FIGS. 22 and 23, as described above an entropy encoder forming part of a video encoding apparatus comprises a first encoding system (for example an arithmetic coding encoding system such as a CABAC encoder 2400) and a second encoding system (such as a bypass encoder 2410), arranged so that a particular data word or value is encoded to the final output data stream by either the CABAC encoder or the bypass encoder but not both. In embodiments of the invention, the data values passed to the CABAC encoder and to the bypass encoder are respective subsets of ordered data values split or derived from the initial input data (the reordered quantised DCT data in this example), representing different ones of the set of “maps” generated from the input data.

The schematic representation in FIG. 22 treats the CABAC encoder and the bypass encoder as separate arrangements. This may well be the case in practice, but in another possibility, shown schematically in FIG. 23, a single CABAC encoder 2420 is used as both the CABAC encoder 2400 and the bypass encoder 2410 of FIG. 22. The encoder 2420 operates under the control of a mode selection signal 2430, so as to operate with an adaptive context model (as described above) when in the mode of the CABAC encoder 2400, and to operate with a fixed 50% probability context model when in the mode of the bypass encoder 2410.

A third possibility combines these two, in that two substantially identical CABAC encoders can be operated in parallel (similar to the parallel arrangement of FIG. 22) with the difference being that the CABAC encoder operating as the bypass encoder 2410 has its context model fixed at a 50% probability context model.

The outputs of the CABAC encoding process and the bypass encoding process can be stored (temporarily at least) in respective buffers 2440, 2450. In the case of FIG. 23, a switch or demultiplexer 2460 acts under the control of the mode signal 2430 to route CABAC encoded data to the buffer 2450 and bypass encoded data to the buffer 2440.

An alternative arrangement using a single buffer will be described below with reference to FIG. 26.

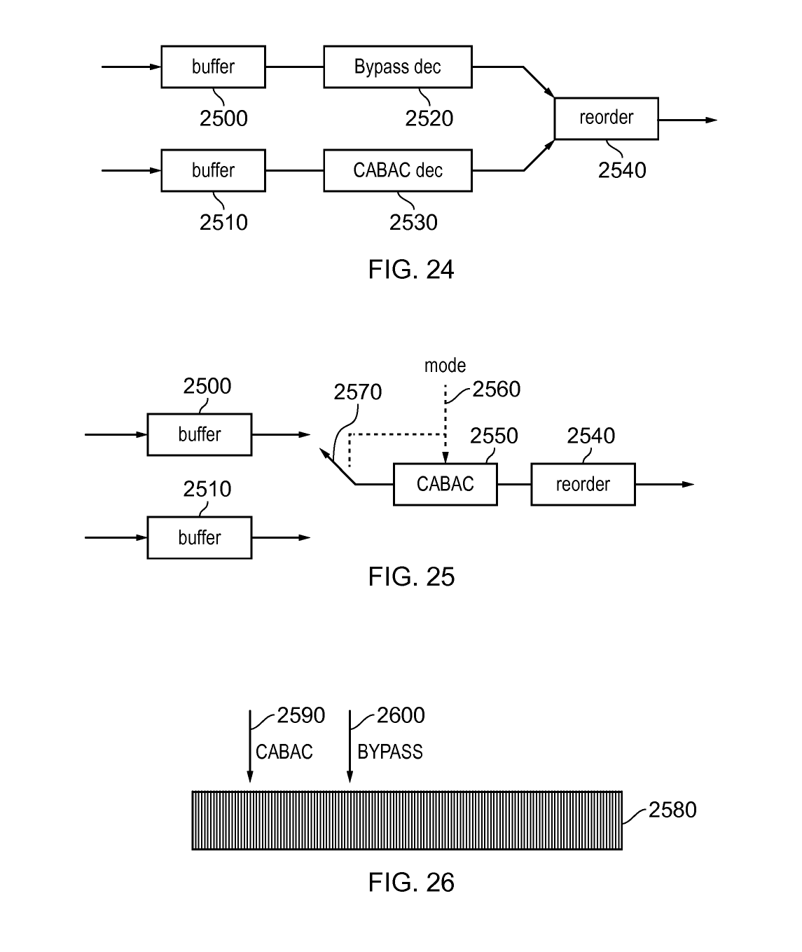

FIGS. 24 and 25 schematically illustrate examples of an entropy decoder forming part of a video decoding apparatus. Referring to FIG. 24, respective buffers 2510, 2500 pass data to a CABAC decoder 2530 and a bypass decoder 2520, arranged so that a particular encoded data word or value is decoded by either the CABAC decoder or the bypass decoder but not both. The decoded data are reordered by logic 2540 into the appropriate order for subsequent decoding stages.

The schematic representation in FIG. 24 treats the CABAC decoder and the bypass decoder as separate arrangements. This may well be the case in practice, but in another possibility, shown schematically in FIG. 25, a single CABAC decoder 2550 is used as both the CABAC decoder 2530 and the bypass decoder 2520 of FIG. 24. The decoder 2550 operates under the control of a mode selection signal 2560, so as to operate with an adaptive context model (as described above) when in the mode of the CABAC decoder 2530, and to operate with a fixed 50% probability context model when in the mode of the bypass encoder 2520.

As before, a third possibility combines these two, in that two substantially identical CABAC decoders can be operated in parallel (similar to the parallel arrangement of FIG. 24) with the difference being that the CABAC decoder operating as the bypass decoder 2520 has its context model fixed at a 50% probability context model.

In the case of FIG. 25, a switch or multiplexer 2570 acts under the control of the mode signal 2560 to route CABAC encoded data to the decoder 2550 from the buffer 2500 or the buffer 2510 as appropriate.

In embodiments of the invention to be described in further detail below, the CABAC encoded data and the bypass encoded data can be multiplexed into a single data stream. More detail of the data stream will be given in the following description, but at this stage it is noted that in such an arrangement the input buffers 2500, 2510 and/or the output buffers 2440, 2450 (as the case may be) can be replaced by a single respective buffer 2580. So, in a decoder arrangement the two input buffers may be replaced by a single buffer, and in an encoder arrangement the two output buffers may be replaced by a single buffer. In FIG. 26, the buffer is shown schematically to include vertical lines delimiting data bits or words, which are intended to assist in the representation that the data contents of the buffer extend in a lateral direction (as represented).

The buffer 2580, and its associated read and write control arrangements, may therefore be considered as an example of an output data assembler for generating an output data stream from the data encoded by first (for example CABAC) and second (for example bypass) encoding systems.

Two buffer pointers 2590, 2600 are shown. In the case of an encoder output buffer, these represent data write pointers indicating positions in the buffer at which next data bits are written. In the case of a decoder input buffer, these represent data read pointers indicating positions in the buffer from which next data bits are read. In embodiments of the invention, the pointer 2590 relates to reading or writing CABAC encoded data and the pointer 2600 relates to reading or writing bypass encoded data. The significance of these pointers and their relative position will be discussed below.

In a basic example of a CABAC encoder and decoder, the encoded bypass data (being data encoded as CABAC but with a fixed 50% probability context model) cannot be introduced into the same data stream as the CABAC encoded data in a raw form as, for any given output CABAC-decoded data bit, the CABAC decoder has already read more bits from the data stream than the encoder had written when the encoder was encoding that particular data bit. In other words, the CABAC decoder reads ahead, in terms of reading further CABAC encoded data from the data stream, and so it is not generally considered possible to introduce the bypass data into the same continuous encoded data stream as the CABAC data. This difference (the amount by which the decoder reads ahead) may be referred to as the “decoder offset”

In other words, while the decoder is processing a binary value, it already has some of the bits for the next few binary values in a register, which is called “value”.

However, if a way could be found to make the bypass data were available in a raw form, multiple bits of the bypass data could be read at once using relatively little logic or processing overhead. Embodiments of the invention do indeed allow this, by making the bypass data available at a predetermined location in the stream. Using the techniques to be described, bypass data can be read at the same time as CABAC data. Accordingly, embodiments of the invention provide a method of splitting the CABAC stream so that bypass data may be placed in the stream in raw form so as to form a composite CABAC/bypass data stream and potentially may be read (at decoding) in parallel with CABAC data.

The basis of the technique is to arrange the CABAC data stream (without bypass data) into packets. Here, a packet refers to a set of adjacent encoded CABAC data bits, having a predetermined length (as a number of bits), where the term “predetermined” implies that the length of a CABAC data packet is, for example, (a) decided in advance, (b) decided by the encoder and communicated in association with the rest of the encoded data stream to the decoder, or (c) derived in a manner known to the decoder and the encoder from previously encoded/decoded data.

After each CABAC packet is written to the output data stream, the bypass data that corresponds to the encoded coefficients contained within that packet is written (in raw form) next to the composite output data stream.

Accordingly, this arrangement provides an example of the generation of an output data stream comprising successive packets of a predetermined quantity of data generated by the first encoding system (for example, CABAC) followed, in a data stream order, by the zero or more data generated by the second encoding system (for example, bypass) in respect of the same data items as those encoded by the first encoding system.

The encoder tracks how many bits the decoder will have read after each decode in order to determine the amount of bypass data following the next packet.

The decoder can load the CABAC packet into a buffer (such as the buffer 2510) and read the bypass data directly from the stream. Or the CABAC and bypass data can be read, using separate pointers (as described with reference to FIG. 26) from a common buffer or stream. In this way, potentially, multiple bypass bits can be read at once, and CABAC and bypass data can be read in parallel so (potentially) increasing the data throughput of the system relative to a system in which the CABAC data and bypass data are encoded into a single data stream using a common arithmetic coding process.

Accordingly, by the elegantly straightforward measure of splitting the CABAC data into packets, it is possible to combine raw bypass data with CABAC data allowing multiple bits to be read at once, and/or to read bypass and CABAC data simultaneously, allowing parallelism and improving throughput.

In embodiments of the invention, a fixed size of 16 bits is used for the CABAC packets. Note that this is a fixed length in terms of the quantity of output data generated; the nature of the CABAC encoding process of course means that 16 bits in a CABAC packet can of course represent a variable amount of input data. The length of 16 bits is larger than the CABAC range (default 9 bits) used in embodiments of the invention. Note also that other packet lengths could be chosen instead,

The CABAC data to initialise the register “value” is placed in the first packet, followed by the CABAC data to renormalise after the first decode, second decode and so on. Each CABAC packet is followed by the raw bypass data for all coefficients for which the renormalised CABAC data are entirely contained within the CABAC packet.

Bypass data for coefficients with renormalised data that run past the end of a particular CABAC packet are placed after the next CABAC packet.

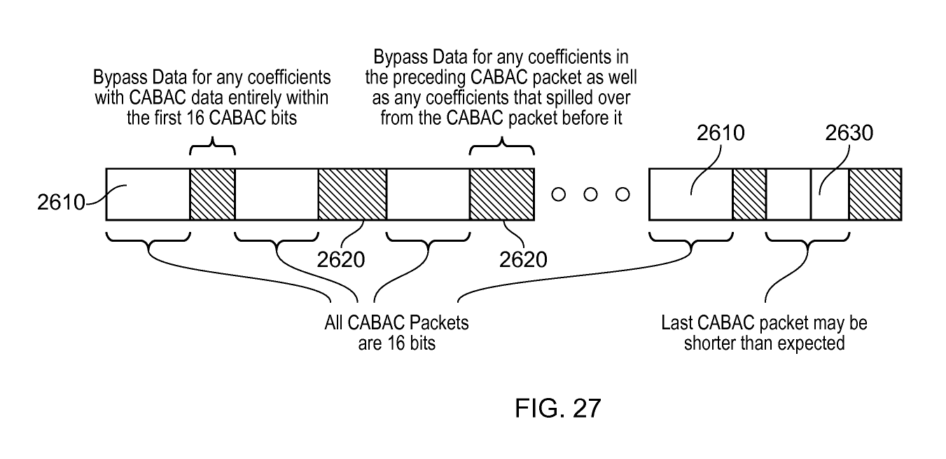

This process is illustrated schematically in FIG. 27, which illustrates a part of a packetised data stream. CABAC packets 2610 are shown as unshaded blocks and bypass packets 2620 are shown as shaded blocks, with the data order running from left to right. Padding zeroes 2630 (see below) are shown in respect of the last CABAC packet. The packetized data stream of FIG. 27 therefore provides an example of video data comprising successive packets of a predetermined quantity of ordered data generated by the first encoding system followed, in a data stream order, by the zero or more data generated by a second encoding system in respect of the same data items as those encoded by a first encoding system, the first and second encoding systems being arranged to entropy encode respective subsets of input video data so that for a predetermined quantity of encoded data generated in respect of a group of data items by the first encoding system, a variable quantity of zero or more data is generated in respect of that group of data by the second encoding system.

Where the video data is encoded on a slice by slice basis (where a slice is a subset of a picture such that decoding is self contained, or independently encoded as independent portions, with respect to the rest of the picture), the last packet relating to a particular slice may be smaller than the expected 16 bits if the CABAC data for that slice does not end on a packet boundary (that is to say, if the CABAC data for the whole slice does not total a multiple of 16 bits). In such circumstances, the last packet will be smaller than 16 bits in length. In this case, the last CABAC packet is padded by the data stream assembler, for example with zeroes, for example by the data stream assembler writing padding data to the buffer and reading it out as part of the last packet, to its expected size. The padding data is not read as the decoder will decode an end-of-slice flag before reaching it. In this technique, the maximum wastage is equal to one bit less than the size of a packet.

However, to reduce wastage, if the last CABAC packet has no associated bypass data (zero bypass data), the final packet could be allowed to be shorter than the expected size—or in other words, padding data is not used. Such a packet may be termed a “short packet”.

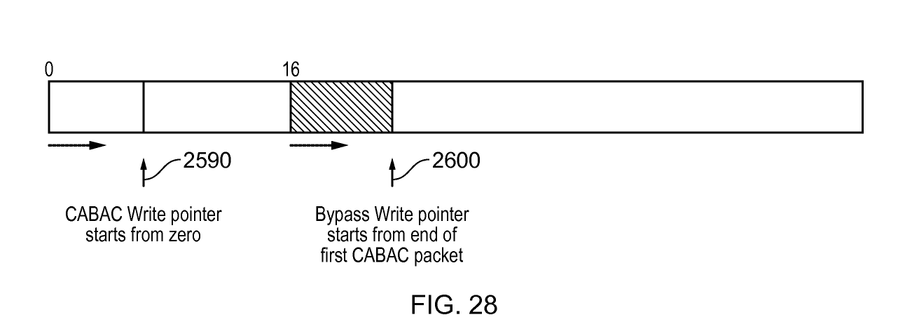

To encode data in packet form in embodiments of the invention, the encoder keeps a buffer (such as the buffer 2580) into which both the CABAC and bypass data can be written. On initialisation, the CABAC write pointer 2590 is set to zero and the bypass write pointer 2600 is set equal to the size of the first CABAC packet (e.g. 16 bits). So, the first bit of CABAC data will be written to the start of the buffer, and the first bit of bypass data (if any) relating to that CABAC packet will be written to a position offset from the first CABAC writing position by 16 bits. This pointer arrangement is illustrated in more detail in FIG. 28.

Each time the encoder detects that the decoder has read 16 bits, the bypass pointer is advanced past the next CABAC packet (that is, advanced by 16 bits from the end of the bypass data for the current packet). Each time the encoder fills a CABAC packet, the CABAC write pointer is advanced past the next bypass packet and the CABAC and bypass data are sent to the stream.

To encode a CABAC Packet-based stream, an output buffer may be used, that can be written to in multiple places.

Two write pointers are used to index this buffer, the first indicating where to write CABAC data (starting at zero) the second indicating where to write bypass data (starting at 16).

Each time the encoder detects that the decoder has read 16 bits, the bypass pointer's position is noted and incremented by 16. When the encoder finishes writing the current ‘CABAC packet’, the CABAC pointer is set equal to the noted previous position of the bypass pointer.

In this way, each pointer “jumps over” the other's data. After any given renormalization, the difference between the total number of bits the decoder has read and the total number of bits the encoder has written can be greater than the size of a packet.

Therefore it is necessary to store multiple previous bypass pointer locations. The required number of pointers is bounded by the maximum difference and is the reason for limiting outstanding bits.

Non-word-aligned writes to the buffer can be executed in a single write cycle by caching the bytes surrounding the target region.

The following steps are pseudocode describing the ongoing encoding process. Explanation of some notation, where necessary, is given in parentheses.

| | | |
|---|---|---|
| Initialise: | set | ptr_CABAC = 0 (CABAC write pointer) |
| | | ptr_bypass = 16 (bypass write pointer) |
| | | ptr_bypass_old = undefined |
| | | decoder_bits_read = 9 (CABAC_RANGE_BITS) |

| | |
|---|---|
| Step 1: | Encode N CABAC bits: |

```
If N bits fit into current packet:
Write bits at ptr_CABAC
      ptr_CABAC += N (replace ptr_CABAC by
      ptr_CABAC + N)
else
      Write bits at ptr_CABAC up to end of packet
      ptr_CABAC = ptr_bypass_old
      write remaining bits (N′) at ptr_CABAC
      ptr_CABAC += N′
decoder_bits_read += N
if decoder_bits_read >= 16
      decoder_bits_read −= 16
      ptr_bypass_old = ptr_bypass
      ptr_bypass += 16
```

Step 2: Encode N bypass bits:

Write bits at ptr_bypass
ptr_bypass += N

Step 3: Repeat step 1 and step 2 as required.

In encoding schemes that require a termination symbol at the end of a set of data, it will be understood that handling the variable number of CABAC bits in the final packet should nevertheless still allow for such a termination symbol. The termination symbol may for example be a bit having a predetermined value of 0 or 1 indicating the end of a network abstraction layer (NAL) data stream.

Using ‘[ . . . ]’ to denote a CABAC packet as described previously herein, ‘C’ to denote a CABAC bit and ‘R’ to denote a termination symbol, a final (short) packet may then for example comprise a bit sequence of the type [CCCCCCCCCCCCCCCR], having in this case 15 CABAC bits and one termination bit.

Notably, in the case of HEVC or AVC systems, in an embodiment of the present invention the last bit of the CABAC stream itself can be replaced by this termination symbol, thus saving one bit. In this case, the final bit of the CABAC stream is replaced with the same value as the termination symbol of the encoding scheme (for example a value of 1). Clearly if the final value of this bit was already 1, then effectively there is no change. If the final value of the bit was 0, then it has the effect of adding 1 to the overall value. However for a symbol range of 2 and for a value at the end of the encoding that is at the bottom of the symbol range, then adding 1 will not move the overall value outside the coding interval, and the data stream remains valid. Hence for HEVC or AVC encoding, more generally the last bit of the CABAC stream can be set equal to a termination symbol whilst remaining within the same coding interval. It will be appreciated that any coding scheme that could similarly tolerate a bit change to the last bit in the stream could take advantage of this technique.

Consequently in this embodiment if the CABAC stream ends in the middle of a packet and there is no bypass data to follow, then the stream is terminated with a short packet as described previously, and the last bit of that short packet will be read as the proper termination symbol and be decoded correctly (for example in an HM4.0 decoding scheme). Using the example above, the resulting short packet would read [CCCCCCCCCCCCCCR], comprising 14 CABAC bits and one termination bit in place of the final 15^{th} CABAC bit.

However, if the CABAC stream ends in the middle of a packet and there is bypass data to follow, the final packet is not truncated to coincide with the end of the CABAC bits, and instead padding bits are provided. However, a termination symbol is still desired.

In this case, in an embodiment of the present invention, to maintain consistency at the encoder and decoder, one or more of the padding bits (a typically all of the padding bits in this embodiment) also use the same value as the termination symbol. Using ‘B’ to denote a bypass bit, the resulting sequence will be of the type [CCCCCCCCCCRRRRRR]BBBBR. Here, 10 CABAC bits are followed by 6 padding bits having the same value as the data termination bit or symbol. After the CABAC packet, the bypass bits are then followed again by the termination symbol.

Again in the case of HEVC, AVC or similarly tolerant schemes, alternatively the final bit of the CABAC bits may again be replaced by the termination symbol, with any additional padding bits also using the same value as the termination symbol. In this case the resulting sequence will be of the type [CCCCCCCCCRRRRRRR]BBBBR. Here, 9 CABAC bits are followed by one termination bit in place of a final 10^{th} CABAC bit, which is followed in turn by 6 padding bits having the same value as the termination bit R. Consequently there are now a total of 7 bits in a row having the value of the termination symbol R in this example. After the CABAC packet, the bypass bits are again followed by the termination symbol.

In either case, in this way a termination symbol is still provided at the end of the CABAC data and also at the end of the bitstream as a whole.

Finally, in a case where the last required CABAC bit (that is, including or excluding the last actual CABAC bit according to the encoding scheme used as described above) exactly fits the 16^{th} bit of the final CABAC packet, then the decoder will automatically continue on to look to where the next expected packet would be and hence the termination symbol can be placed at this position. Hence example sequences in this case include [CCCCCCCCCCCCCCCC]R, and [CCCCCCCCCCCCCCCC]BBBBR.

Separately or in addition, it is also possible to terminate a CABAC stream early in order to insert different data (such as IPCM lossless code). As a result, the CABAC stream may again terminate as a short packet, but again where there is also bypass data then the final packet may again include padding bits. In this case, again to save bits one or more of the padding bits may be replaced with (take the values of) the corresponding first bits at the beginning of the inserted data (of the subsequent stream). Using ‘D’ to denote the different data, the resulting packet will then comprise a sequence of the type [CCCCCCCDDDDDDDDD]BBBBR or (with reference to the HEVC or AVC examples above) [CCCCCCCRDDDDDDDD]BBBBR.

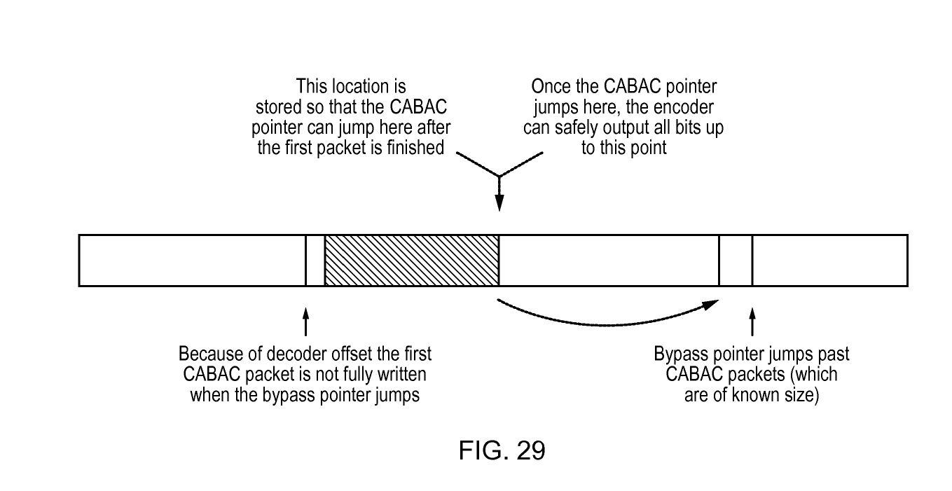

Outstanding bits will now be considered with reference to FIG. 29. As part of this consideration, in embodiments of the invention the encoder maintains a list of pointers to where bypass packets finished. The length of the list depends on the decoder offset mentioned above. In general terms:

Decoder offset=CABAC_RANGE_BITS (default 9)+number of outstanding bits

Normally the decoder offset is theoretically unbounded, however, it is proposed that a mechanism be provided for limiting the outstanding bits, allowing the encoder to maintain a smaller number of pointers.

The required number of pointers is given by:

round up the value of (maximum decoder offset/CABAC packet size)

Outstanding bits are a potential problem with arithmetic coders when the encoder knows that the data encoded so far is in the range (for example in decimal, rather than the usual binary) 0.49 to 0.51—the encoder does not know whether to output 0.4 (for the first significant figure) or 0.5. The encoder has to defer outputting the information until it knows what to do. For each deferred decision, the encoder has written one less bit to the stream than would be needed, and therefore the decoder offset is increased. Eventually, the problem is resolved, and the encoder can write out the missing values, reducing the decoder offset back to 9. However, it must write all the missing values into the buffer at the correct places, and therefore must remember where in the stream buffer it can write to.

The number of places it must therefore keep track of is a function of the decoder offset and the packet size. If the offset is <=16, it can be appropriate just to keep track of the normal write pointer and an older write pointer, but if the offset>16, an additional older write position may need to be tracked; if offset>32, two additional older write positions need to be recorded, and so on.

A further aspect of outstanding bits will now be discussed. In order to output the stream in the correct order, the ‘Bypass packets’ must be saved by the encoder until their corresponding ‘CABAC packets’ have been generated.

Since the encoder may defer writing bits for a long time, even up to the entire stream, due to those bits being outstanding, the number of ‘Bypass packets’ that must be buffered is potentially unbounded.

To limit the number of ‘Bypass packets’ that must be buffered, it is useful to limit the number of outstanding bits, for example using stream termination

This method allows the outstanding bits to be limited to a fixed number without requiring that they are checked after every renormalisation. To enable this method, the decoder tracks m_low as it would appear in the encoder.

Bits renormalized from m_low are accumulated in a buffer. If, after renormalization, at least a certain number of bits have accumulated in the buffer, they are considered to form a ‘group’. The minimum group size could, in embodiments of the invention, be 15 bits. The maximum group size would therefore be equal to 22 (14+8 (8 bits being the maximum possible renormalization)).

In the encoder, the first group is stored in a buffer. If a subsequent group is not outstanding, the group currently in the buffer is flushed to the stream along with any outstanding bits. The new group is then stored in the buffer.

If all the bits in a group are ones and there is no carry, the group is considered to be outstanding. The encoder and decoder each keep a count of the number of outstanding groups. The encoder also keeps a count of the sum of the outstanding group sizes so that it knows how many outstanding bits need to be flushed when a non-outstanding group is encountered.

If a number of outstanding groups greater than or equal to a defined limit is encountered, the stream is terminated. This ensures the next group will not be outstanding, allowing the accumulated outstanding groups to be flushed.

Using this method, the maximum possible count of outstanding bits is equal to the maximum group size multiplied by the limiting number of outstanding groups.

Accordingly, embodiments of the invention can provide a buffer for accumulating data renormalized from m_low (a register indicating a lower limit of a CABAC range), and for associating the stored data as a group if the group has at least a predetermined data quantity;

a detector for detecting whether all of the data in a group have the data value one with no carry, and if so for designating the group as a group of a first type; if not, the group is designated as a group of a second type;

a buffer reader for reading a group of the first type from the buffer if a subsequently stored group is of the second type, and inserting the read group into the output data stream;

a detector for detecting the presence in the buffer of more than a predetermined number of groups of the first type, and if so, for terminating and restarting encoding of the data.

The operation of the decoder will now be described.

In general terms, a CABAC Packet-based stream can be decoded using a shift register as the buffer. Each time data is read from the buffer by the decoder or control logic provided within the decoder acting as a buffer reader, the remaining bits are shifted to fill the space occupied by the read bits, and new data from the stream is added to the end of the register.

CABAC data is read into m_value from the front of the shift register (acting as an input buffer), both at the start of decoding and after each renormalization.

Bypass data is read from a position indicated by a bypass index. This index is initially set to 16 (the start of the first ‘Bypass packet’) and decremented on each read of CABAC data by the number of bits read.

In a parallel system, both CABAC and bypass read-and-shifts happen simultaneously. Decoders such as the decoders 2520 and 2530 may act as an entropy decoder to decode the respective subsets of data read from the buffer.

At the end of a ‘CABAC packet’ (i.e. when a CABAC read passes the bypass index), the bypass index is incremented by 16, jumping it past the next ‘CABAC packet’. This can be achieved without a stall in a parallel system by speculatively reading from a position equal to the bypass index plus 16 as well as the bypass index itself.

The data in a ‘Bypass packet’ attaches only to CABAC data within the preceding ‘CABAC packet’. This ensures that, by the time a CABAC read would pass the end of the current ‘CABAC packet’, all the data in the associated ‘Bypass packet’ will have been read and therefore the end of the current ‘CABAC packet’ is directly adjacent to the start of the next.

This allows CABAC data to always be safely read past the end of the current ‘CABAC packet’ as though it were one continuous stream.

The size of the shift register is determined by the need to read the maximum possible number of bypass bits from the furthest possible position and is calculated to be 67 bits ((8−1+16) {furthest bypass read index}+44 {largest possible bypass read}), assuming coefficients have maximum magnitude of 32768 (16 bit signed).

The decoder can maintain a buffer or shift register (for example the buffer 2580 of the type shown in FIG. 26) to allow both types of data (CABAC and bypass) to be manipulated at the same time.

The minimum size of buffer=(CABAC_RANGE_BITS−2)+PACKET_SIZE+MAX_BYPASS_LENGTH; for example, using a set of previously proposed parameters, the minimum size=(9−2)+16+44=67

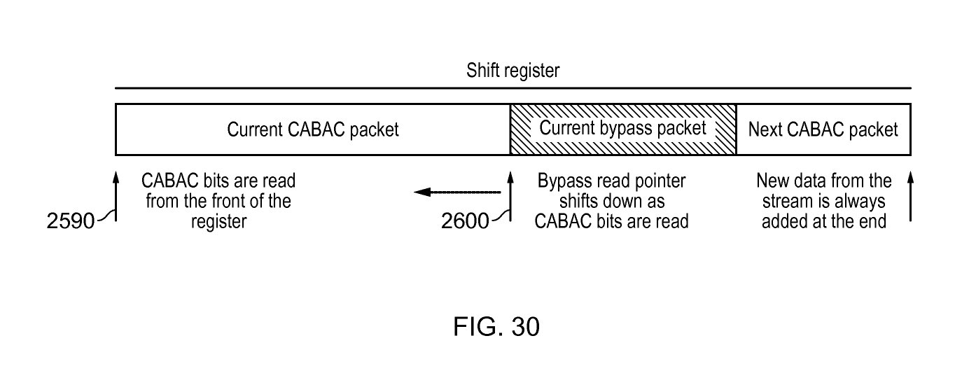

Bypass data is read from a position indicated by a bypass read pointer 2600. An example of the buffer in use is shown schematically in FIG. 30.

The decoder speculatively evaluates the bits immediately following the bypass read pointer, determining how many bits are to be read if . . .

A) no bypass bits are required (coefficient magnitude=0)

B) only a sign bit is required (coefficient magnitude=1 or 2)

C) a sign bit and escape code are required (all other magnitudes)

In addition, the decoder also speculatively decodes at (bypass pointer+16) (if valid) (see below).

Referring to FIG. 30, after each CABAC renormalisation, CABAC data is read into the register “value” from the front of the buffer (the front being shown at the left of FIG. 30), shifting all other bits left along with the bypass read pointer 2600. In other words, in this example, reading data from the buffer has the effect of removing that data from the buffer. Bypass data is read (depending on the magnitude determined by the CABAC decode process) from the position indicated by the bypass pointer 2600, again shifting all bits to the right of the bypass read pointer further down (to the left in) the buffer.

An amount of new data equal to the sum of both shifts is added at the end of the buffer (that is, the right-hand end as shown in FIG. 30) from the encoded data stream. In other words, the buffer is refilled after these read operations.

At the end of a CABAC packet (when the CABAC read pointer passes the bypass pointer), the bypass index is jumped to a position immediately past the next CABAC packet.

The bypass packet must be empty at that point (because the bypass bits that were in that packet correspond to coefficients contained entirely within the CABAC packet) so the CABAC pointer can always safely read past the end of the packet as though it were one continuous stream.

Having speculatively evaluated the bits at (bypass read pointer+16), it is possible in this case to ensure an instant jump to the next bypass packet requiring no additional processing delay at all.

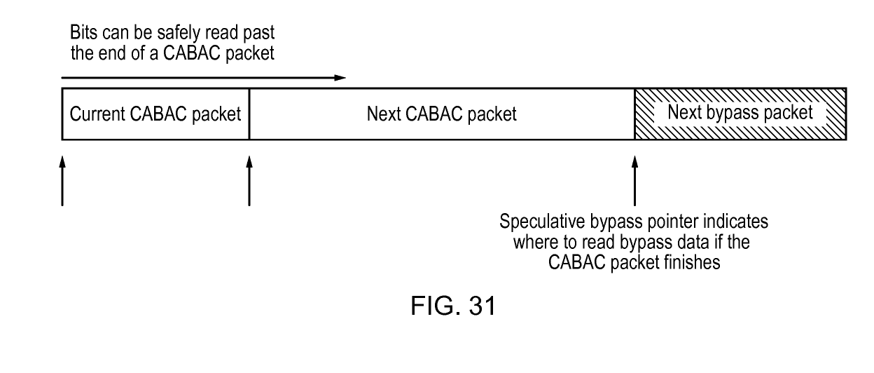

This process is illustrated schematically in FIG. 31. Note that the CABAC packet shown to the left is a schematic illustration of the currently unread contents of a current packet—that is to say, it shows only a remaining portion of a current packet.

In general terms, the speculative pointer is always 16 bits higher than the main pointer: the idea is that if it is necessary to access the data at the main pointer (because it is the start of a new packet), the decoder would already have decoded the first bypass data at the start of the next bypass packet. In other words, this helps to ensure that the bypass data has been interpreted.

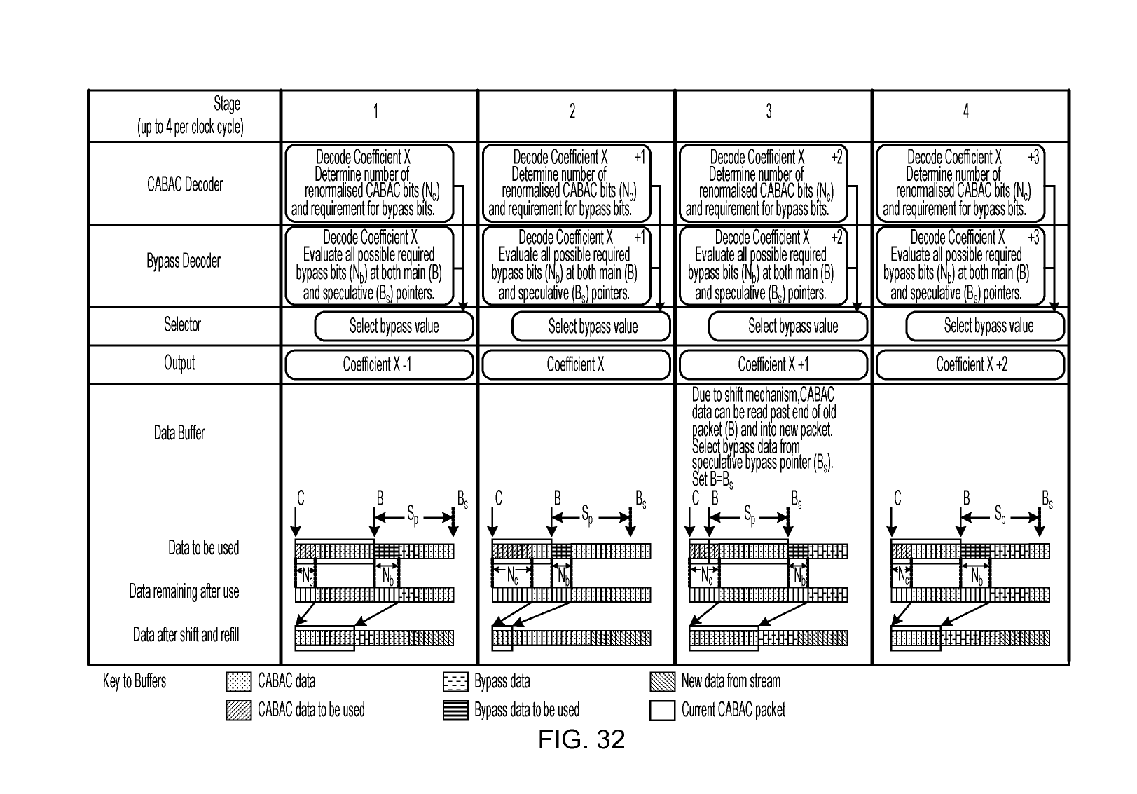

The following pseudocode steps, using the same notation as the earlier pseudocode, describe the decoding process and may be read in conjunction with FIG. 32, which illustrates four processing stages, shown as successive columns within FIG. 32, noting that in embodiments of the invention up to four such stages may be completed in each decoding clock cycle:

| | |
|---|---|
| Initialise: | Fill the register “value” with |
| | (CABAC_RANGE_BITS) from stream |
| | Fill shift register from stream |
| | index_bypass = |
| | (16 − CABAC_RANGE_BITS) |
| | (set bypass read pointer) |

Step 1a (in parallel with step 1b): Decode CABAC data:

```
        Determine symbol ranges
        Compare the register “value” with symbol
              ranges to determine symbol (magnitude)
        Determine number of renormalisation bits for
        CABAC data (Nc)
        value <<= Nc
```

Step 1b (in parallel with step 1a): Decode bypass data:

```
        Decode sign bit Sn from position index_bypass;
        Decode escape data En from position
        (index_bypass + 1);
              Nbn = (escape length + 1)
        Decode sign bit Ss from position
        (index_bypass + 16);
        Decode escape data Es from position
        (index_bypass + 17);
              Nbs = (escape length + 1)
```

Step 1c (after step 1a and 1b):

```
        if (Nc > index_bypass)
                    - New packet encountered -
              use speculative path escape = Es ;
              sign=Ss ; Nb_escape=Nbs;
              Index_bypass+=16
        Else
              escape = En; sign=Sn; Nb_escape=Nbn
        If (magnitude > 2)
              output = (magnitude + escape) * sign;
              Nb = Nb_escape
        Else if (magnitude > 0)
              output = (magnitude * sign); Nb = 1
        Else
              output = 0; Nb = 0
```

Step 2: shift and refill:

```
        Shift register <<= Nc
        index_bypass −= Nc
        Shift register[index_bypass to end] <<= Nb
        Read (Nc + Nb) bits from stream into last bits of
        shift register
```

Splitting the CABAC data into packets can be particularly beneficial for intra-image mode. In inter-image mode, transform coefficient data is often sparse, and some CUs/LCUs may contain no coefficients at all. This arises because the inter-mode motion vectors can often provide better predictions than those obtainable in intra-image mode, and hence the quantised residual data is often small/non-existent.

The higher density of data in intra mode places a higher requirement on encoder/decoder throughput and therefore a greater desire for parallelism.

These methods can give a number of benefits to implementation.

CABAC and bypass data can be read at the same time, allowing decoding in parallel.

Multiple bits of bypass data can be read at the same time. This allows all the bypass data for a coefficient to be decoded in one stage.

Only a small decoder buffer is required. With a packet size of 16 bits and CABAC_RANGE_BITS of 9, only a 67-bit buffer is required.

The techniques could be adapted to work in a multiple-coefficient-per-cycle system.

The techniques can increase throughput.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. Data coding apparatus in which a set of ordered data is encoded, comprising:
an entropy encoder configured to encode the ordered data, in which each data item is split into respective subsets of data and the respective subsets are encoded by first and second encoding systems so that for a predetermined quantity of encoded data generated in respect of a group of data items by the first encoding system, a variable quantity of zero or more data is generated in respect of that group of data by the second encoding system; and
an output data stream assembler configured to generate an output data stream from the data encoded by the first and second encoding systems, the output data stream comprising successive packets of a predetermined quantity of data generated by the first encoding system followed, in a data stream order, by the zero or more data generated by the second encoding system in respect of the same data items as those encoded by the first encoding system.

2. The apparatus according to claim 1, in which the first encoding system is an arithmetic coding encoding system, and the second encoding system is a bypass encoding system.

3. The apparatus according to claim 2, in which the first encoding system is a context adaptive binary arithmetic coding (CABAC) encoding system.

4. The apparatus according to claim 1, in which the set of ordered data represents one or more images.

5. The apparatus according to claim 1, in which the set of ordered data are encoded in independently encoded portions, the data stream assembler being configured to generate a data stream in respect of a portion, and to add padding data to a final packet encoded by the first encoding system in respect of the ordered data if that final packet is smaller than the predetermined quantity of data.

6. The apparatus according to claim 5, in which one or more of the bits of the padding data has the same value as a data termination symbol.

7. The apparatus according to claim 5, in which one or more respective bits of the padding data take the values of corresponding respective bits at the beginning of a subsequent data stream.

8. The apparatus according to claim 5, in which the data stream assembler is configured not to add padding data to a final packet if the encoding of the corresponding coefficients by the second encoding system generates zero data.

9. The apparatus according to claim 1, comprising a frequency domain transformer configured to generate frequency domain coefficients dependent upon respective portions of an input data signal and ordering the coefficients for encoding according to an encoding order.

10. A data coding method in which a set of ordered data is encoded, comprising:
splitting each data item into respective subsets of data;
entropy encoding the respective subsets by first and second encoding systems so that for a predetermined quantity of encoded data generated in respect of a group of data items by the first encoding system, a variable quantity of zero or more data is generated in respect of that group of data by the second encoding system; and
generating by circuitry an output data stream from the data encoded by the first and second encoding systems, the output data stream comprising successive packets of a predetermined quantity of data generated by the first encoding system followed, in a data stream order, by the zero or more data generated by the second encoding system in respect of the same data items as those encoded by the first encoding system.

11. Video data encoded by the encoding method of claim 10.

12.-13. (canceled)

14. Video decoding apparatus for decoding data according to claim 11, the apparatus comprising:
an input buffer configured to store the encoded data;
a buffer reader for configured to read respective data of the first and second subsets from each packet; and
an entropy decoder configured to decode the first and second subsets to generate ordered decoded data.

15. A data decoding method for decoding video data according to claim 11, the method comprising:
storing the encoded data in an input buffer;
reading respective data of the first and second subsets from each packet in the input buffer; and
entropy decoding the first and second subsets to generate ordered decoded data.

16.-18. (canceled)
